(19) United States
(12) Patent Application Publication
(10) Pub. No.: US 2026/0161987 A1
(43) Pub. Date: Jun. 11, 2026

(54) ENTANGLEMENT GENERATORS WITH INCORPORATED MULTIPLEXING

(71) Applicant: Psiquantum, Corp., Palo Alto, CA (US)

(72) Inventor: Terence Rudolph, San Francisco, CA (US)

(73) Assignee: Psiquantum, Corp., Palo Alto, CA (US)

(21) Appl. No.: 18/998,112

(22) PCT Filed: Jul. 24, 2023
(86) PCT No.: PCT/US2023/028465

§ 371 Date: Jan. 23, 2025

Related U.S. Application Data
(60) Provisional application No. 63/391,980, filed on Jul. 25, 2022.

(51) Int. Cl. G06N 10/40; G02F 3/00

(52) U.S. Cl. CPC G06N 10/40; G02F 3/00

(57) ABSTRACT

Heralded single photon source pair circuits can produce a photon on one of two output waveguides without determining which waveguide has the photon. Such circuits can be used, for example, to provide qubits in a superposition of their orthogonal states. An entangled-state generator circuit can operate on one of the output waveguides of each of a number of heralded single photon source pair circuits to produce a set of photonic qubits in a target entangled state (such as a Bell state or n-GHZ state) on the other output waveguides of some or all of the heralded single photon source pair circuits.

### CROSS-REFERENCE TO RELATED APPLICATION

This application claims the benefit of U.S. Provisional Application No. 63/391,980, filed Jul. 25, 2022, which is incorporated herein by reference.

### BACKGROUND

At the most general level, a qubit is a quantum system that can exist in one of two orthogonal states (denoted as |0 [symbol] and |1 [symbol] in the conventional bra/ket notation) or in a superposition of the two states

$$( e . g . , \frac{1}{\sqrt{2}} ( \vert 0 〉 + \vert 1 〉 ) .$$

Multiple qubits can be placed into entangled states, and physical systems of entangled qubits have a variety of applications in quantum computing, quantum communication, and other fields. Thus, techniques for creating entanglement between qubits are desirable.

### SUMMARY

Certain aspects of this disclosure relate to optical circuits that can produce a photon on one of two output waveguides without determining which waveguide has the photon. Such circuits can be used, for example, to provide qubits in a superposition of their orthogonal states. According to some embodiments, a circuit can include a first heralded single photon source operable to produce a pair of first photons, the first heralded single photon source having a first signal output path to receive a first photon of the pair of first photons and a first herald output path to receive a second photon of the pair of first photons; a second heralded single photon source operable to produce a pair of second photons, the second heralded single photon source having a second signal output path to receive a first photon of the pair of second photons and a second herald output path to receive a second photon of the pair of second photons; a mode coupling optical circuit coupled between the first herald output path and the second herald output path, the mode coupling optical circuit having a first mode-coupling output path and a second mode-coupling output path; a first detector configured to detect photons from the first mode-coupling output path; a second detector configured to detect photons from the second mode-coupling output path; and a classical decision logic circuit coupled to the first detector and the second detector and configured to determine whether a photon was detected on exactly one of the first mode-coupling output path and the second mode-coupling output path and to generate a success signal indicating whether a photon was detected on exactly one of the first mode-coupling output path and the second mode-coupling output path.

Certain aspects of this disclosure relate to optical circuits that can produce a pair of qubits in an entangled state, such as Bell state. According to some embodiments, a circuit can include: a plurality of heralded single photon source pairs, wherein each heralded single photon source pair has a first output optical path, a second output optical path, and a digital logic output signal path, wherein the heralded single photon source pair is configured to generate photons on the first and second output paths, to determine whether exactly one photon is present on the first and second output paths without determining on which of the first and second output paths the exactly one photon is present, and to output a success signal on the digital logic output signal path, the success signal indicating whether exactly one photon is present on the first and second output paths; a mode coupler network having a plurality of inputs and a plurality of outputs, the mode coupler network being configured such that a photon received on any one of the inputs has an equal probability of being output on any one of the outputs, wherein the inputs of the mode coupler network are coupled to the second output optical paths of the heralded single photon source pairs; a plurality of detectors coupled to the outputs of the mode coupler network and configured to detect photons; and a classical decision logic circuit coupled to the detectors and configured to determine, based on signals received from the detectors, whether a Bell state is present on four of the first output optical paths. In some embodiments, the number of inputs of the mode coupler network can be equal to the number of heralded single photon sources, and the switch circuit can be omitted.

The following detailed description, together with the accompanying drawings, will provide a better understanding of the nature and advantages of the claimed invention.

### BRIEF DESCRIPTION OF THE DRAWINGS

FIG. 1 shows two representations of a portion of a pair of waveguides corresponding to a dual-rail-encoded photonic qubit.

FIG. 2A shows a schematic diagram for coupling of two modes.

FIG. 2B shows, in schematic form, a physical implementation of mode coupling in a photonic system that can be used in some embodiments.

FIGS. 3A and 3B show, in schematic form, examples of physical implementations of a Mach-Zehnder Interferometer (MZI) configuration that can be used in some embodiments.

FIG. 4A shows another schematic diagram for coupling of two modes.

FIG. 4B shows, in schematic form, a physical implementation of the mode coupling of FIG. 4A in a photonic system that can be used in some embodiments.

FIG. 5 shows a four-mode coupling scheme that implements a “spreader,” or “mode-information erasure,” transformation on four modes in accordance with some embodiments.

FIG. 6 illustrates an example optical device that can implement the four-mode mode-spreading transform shown schematically in FIG. 5 in accordance with some embodiments.

FIG. 7 shows a circuit diagram for a dual-rail-encoded Bell state generator that can be used in some embodiments.

FIG. 8A shows a circuit diagram for a dual-rail-encoded type I fusion gate that can be used in some embodiments.

FIG. 8B shows example results of type I fusion operations using the gate of FIG. 8A.

FIG. 9A shows a circuit diagram for a dual-rail-encoded type II fusion gate that can be used in some embodiments.

FIG. 9B shows an example result of a type II fusion operation using the gate of FIG. 9A.

FIG. 10 illustrates an example of a qubit entangling system in accordance with some embodiments.

FIG. 11 shows a simplified schematic diagram of a Bell state generator (BSG) circuit 1100 according to some embodiments.

FIG. 12 shows a simplified schematic diagram of a Bell state generator circuit according to some embodiments.

FIG. 13 shows a simplified schematic diagram of a switch circuit that can be used in the circuit of FIG. 12 according to some embodiments.

FIG. 14 shows a simplified schematic diagram of a Bell state generator circuit according to some embodiments.

FIG. 15 shows a simplified schematic diagram of a switch circuit that can be used in the circuit of FIG. 14 according to some embodiments.

FIG. 16 shows a simplified schematic diagram of another switch circuit that can be used in the circuit of FIG. 14 according to some embodiments.

FIG. 17 shows a simplified schematic diagram of a Bell state generator circuit according to some embodiments.

FIG. 18 shows a simplified schematic diagram of a 3-GHZ state generator circuit according to some embodiments.

FIG. 19 shows an example of a truth table that can be implemented in a decision logic circuit according to some embodiments.

FIG. 20 shows a simplified schematic diagram of an n-GHZ state generator circuit according to some embodiments.

FIG. 21 shows a simplified schematic diagram of an n-GHZ state generator circuit according to some embodiments.

### DETAILED DESCRIPTION

Disclosed herein are examples (also referred to as “embodiments”) of systems and methods for producing entangled states in physical quantum systems, including photonic systems. Such embodiments can be used, for example, in quantum computing as well as in other contexts (e.g., quantum communication) that exploit quantum entanglement. To facilitate understanding of the disclosure, an overview of relevant concepts and terminology is provided in Section 1. With this context established, Section 2 describes examples of entanglement generators according to various embodiments. Although embodiments are described with specific detail to facilitate understanding, those skilled in the art with access to this disclosure will appreciate that the claimed invention can be practiced without these details.

Further, embodiments are described herein as creating and operating on systems of qubits, where the quantum state space of a qubit can be modeled as a 2-dimensional vector space. Those skilled in the art with access to this disclosure will understand that techniques described herein can be applied to systems of “qudits,” where a qudit can be any quantum system having a quantum state space that can be modeled as a (complex) n-dimensional vector space (for any integer n), which can be used to encode n bits of information. For the sake of clarity of description, the term “qubit” is used herein, although in some embodiments the system can also employ quantum information carriers that encode information in a manner that is not necessarily associated with a binary bit, such as a qudit.

### 1. Overview of Quantum Computing

Quantum computing relies on the dynamics of quantum objects, e.g., photons, electrons, atoms, ions, molecules, nanostructures, and the like, which follow the rules of quantum theory. In quantum theory, the quantum state of a quantum object is described by a set of physical properties, the complete set of which is referred to as a mode. In some embodiments, a mode is defined by specifying the value (or distribution of values) of one or more properties of the quantum object. For example, in the case where the quantum object is a photon, modes can be defined by the frequency of the photon, the position in space of the photon (e.g., which waveguide or superposition of waveguides the photon is propagating within), the associated direction of propagation (e.g., the k-vector for a photon in free space), the polarization state of the photon (e.g., the direction (horizontal or vertical) of the photon's electric and/or magnetic fields), a time window in which the photon is propagating, the orbital angular momentum state of the photon, and the like.

For the case of photons propagating in a waveguide, it is convenient to express the state of the photon as one of a set of discrete spatio-temporal modes. For example, the spatial mode kᵢ of the photon is determined according to which one of a finite set of discrete waveguides the photon is propagating in, and the temporal mode tⱼ is determined by which one of a set of discrete time periods (referred to herein as “bins”) the photon is present in. In some photonic implementations, the degree of temporal discretization can be provided by a pulsed laser which is responsible for generating the photons. In examples below, spatial modes will be used primarily to avoid complication of the description. However, one of ordinary skill will appreciate that the systems and methods can apply to any type of mode, e.g., temporal modes, polarization modes, and any other mode or set of modes that serves to specify the quantum state. Further, in the description that follows, embodiments will be described that employ photonic waveguides to define the spatial modes of the photon.

However, persons of ordinary skill in the art with access to this disclosure will appreciate that other types of mode, e.g., temporal modes, energy states, and the like, can be used without departing from the scope of the present disclosure. In addition, persons of ordinary skill in the art will be able to implement examples using other types of quantum systems, including but not limited to other types of photonic systems.

For quantum systems of multiple indistinguishable particles, rather than describing the quantum state of each particle in the system, it is useful to describe the quantum state of the entire many-body system using the formalism of Fock states (sometimes referred to as the occupation number representation). In the Fock state description, the many-body quantum state is specified by how many particles there are in each mode of the system. For example, a multi-mode, two particle Fock state |1001 [symbol] specifies a two-particle quantum state with one particle in mode 1, zero particles in mode 2, zero particles in mode 3, and one particle in mode 4. Again, as introduced above, a mode can be any property of the quantum object. For the case of a photon, any two modes of the electromagnetic field can be used, e.g., one may design the system to use modes that are related to a degree of freedom that can be manipulated passively with linear optics. For example, polarization, spatial degree of freedom, or angular momentum could be used. The four-mode system represented by the two-particle Fock state |1001 [symbol] can be physically implemented as four distinct waveguides with two of the four waveguides having one photon travelling within them. Other examples of a state of such a many-body quantum system include the four-particle Fock state |1111 [symbol] that represents each mode occupied by one particle and the four-particle Fock state |2200 [symbol] that represents modes 1 and 2 respectively occupied by two particles and modes 3 and 4 occupied by zero particles. For modes having zero particles present, the term “vacuum mode” is used. For example, for the four-particle Fock state |2200 [symbol] modes 3 and 4 are referred to herein as “vacuum modes.” Fock states having a single occupied mode can be represented in shorthand using a subscript to identify the occupied mode. For example, |0010 [symbol] is equivalent to |1₃ [symbol] .

### 1.1. Qubits

As used herein, a “qubit” (or quantum bit) is a quantum system with an associated quantum state that can be used to encode information. A quantum state can be used to encode one bit of information if the quantum state space can be modeled as a (complex) two-dimensional vector space, with one dimension in the vector space being mapped to logical value 0 and the other to logical value 1. In contrast to classical bits, a qubit can have a state that is a superposition of logical values 0 and 1. More generally, a “qudit” can be any quantum system having a quantum state space that can be modeled as a (complex) n-dimensional vector space (for any integer n), which can be used to encode n bits of information. For the sake of clarity of description, the term “qubit” is used herein, although in some embodiments the system can also employ quantum information carriers that encode information in a manner that is not necessarily associated with a binary bit, such as a qudit. Qubits (or qudits) can be implemented in a variety of quantum systems. Examples of qubits include: polarization states of photons; presence of photons in waveguides; or energy states of molecules, atoms, ions, nuclei, or photons. Other examples include other engineered quantum systems such as flux qubits, phase qubits, or charge qubits (e.g., formed from a superconducting Josephson junction); topological qubits (e.g., Majorana fermions); or spin qubits formed from vacancy centers (e.g., nitrogen vacancies in diamond).

A qubit can be “dual-rail encoded” such that the logical value of the qubit is encoded by occupation of one of two modes of the quantum system. For example, the logical 0 and 1 values can be encoded as follows:

$${{\vert 0 〉}_{L} = \vert 10 〉}_{1 , 2} \qquad ( 1 )$$

$${{\vert 1 〉}_{L} = \vert 01 〉}_{1 , 2} \qquad ( 2 )$$

where the subscript “L” indicates that the ket represents a logical state (e.g., a qubit value) and, as before, the notation |ij [symbol] on the right-hand side of the equations above indicates that there are i particles in a first mode and j particles in a second mode, respectively (e.g., where i and j are integers). In this notation, a two-qubit system having a logical state |0 [symbol] 1 [symbol] a state of two qubits, the first qubit being in a ‘0’ logical state and the second qubit being in a ‘1’ logical state) may be represented using occupancy across four modes by |1001 [symbol] (e.g., in a photonic system, one photon in a first waveguide, zero photons in a second waveguide, zero photons in a third waveguide, and one photon in a fourth waveguide). In some instances throughout this disclosure, the various subscripts are omitted to avoid unnecessary mathematical clutter.

### 1.2. Entangled States

Many of the advantages of quantum computing relative to “classical” computing (e.g., conventional digital computers using binary logic) stem from the ability to create entangled states of multi-qubit systems. In mathematical terms, a state |ψ [symbol] of n quantum objects is a separable state if |ψ [symbol] =|ψ₁ [symbol] ⊗ . . . ⊗|ψₙ [symbol] , and an entangled state is a state that is not separable. One example is a Bell state, which, loosely speaking, is a type of maximally entangled state for a two-qubit system, and qubits in a Bell state may be referred to as a Bell pair. For example, for qubits encoded by single photons in pairs of modes (a dual-rail encoding), examples of Bell states include:

$$\vert {Φ}^{+} 〉 = \frac{{{{{\vert 0 〉}_{L} \vert 0 〉}_{L} + \vert 1 〉}_{L} \vert 1 〉}_{L}}{\sqrt{2}} = \frac{\vert 10 〉 \vert 10 〉 + \vert 01 〉 \vert 01 〉}{\sqrt{2}} \qquad ( 3 )$$

$$\vert {Φ}^{-} 〉 = \frac{{{{{\vert 0 〉}_{L} \vert 0 〉}_{L} - \vert 1 〉}_{L} \vert 1 〉}_{L}}{\sqrt{2}} = \frac{\vert 10 〉 \vert 10 〉 - \vert 01 〉 \vert 01 〉}{\sqrt{2}} \qquad ( 4 )$$

$$\vert {Ψ}^{+} 〉 = \frac{{{{{\vert 0 〉}_{L} \vert 1 〉}_{L} + \vert 1 〉}_{L} \vert 0 〉}_{L}}{\sqrt{2}} = \frac{\vert 10 〉 \vert 01 〉 + \vert 01 〉 \vert 10 〉}{\sqrt{2}} \qquad ( 5 )$$

$$\vert {Ψ}^{-} 〉 = \frac{{{{{\vert 0 〉}_{L} \vert 1 〉}_{L} - \vert 1 〉}_{L} \vert 0 〉}_{L}}{\sqrt{2}} = \frac{\vert 10 〉 \vert 01 〉 - \vert 01 〉 \vert 01 〉}{\sqrt{2}} \qquad ( 6 )$$

More generally, an n-qubit Greenberger-Horne-Zeilinger (GHZ) state (or “n-GHZ state”) is an entangled quantum state of n qubits. For a given orthonormal logical basis, an n-GHZ state is a quantum superposition of all qubits being in a first basis state superposed with all qubits being in a second basis state:

$$\vert GHZ 〉 = \frac{{{\vert 0 〉}^{⊗ n} + \vert 1 〉}^{⊗ n}}{\sqrt{2}} \qquad ( 7 )$$

where the kets above refer to the logical basis. For example, for qubits encoded by single photons in pairs of modes (a dual-rail encoding), a 3-GHZ state can be written:

$$\vert GHZ 〉 = \frac{{{{{{{\vert 0 〉}_{L} \vert 0 〉}_{L} \vert 0 〉}_{L} - \vert 1 〉}_{L} \vert 1 〉}_{L} \vert 1 〉}_{L}}{\sqrt{2}} = \frac{\vert 10 〉 \vert 10 〉 \vert 10 〉 + \vert 01 〉 \vert 01 〉 \vert 01 〉}{\sqrt{2}} \qquad ( 8 )$$

where the kets above refer to photon occupation number in six respective modes (with mode subscripts omitted).

### 1.3. Physical Implementations

Qubits (and operations on qubits) can be implemented using a variety of physical systems. In some examples described herein, qubits are provided in an integrated photonic system employing waveguides, beam splitters, photonic switches, and single photon detectors, and the modes that can be occupied by photons are spatiotemporal modes that correspond to presence of a photon in a waveguide. Modes can be coupled using mode couplers, e.g., optical beam splitters, to implement transformation operations, and measurement operations can be implemented by coupling single-photon detectors to specific waveguides. One of ordinary skill in the art with access to this disclosure will appreciate that modes defined by any appropriate set of degrees of freedom, e.g., polarization modes, temporal modes, and the like, can be used without departing from the scope of the present disclosure. For instance, for modes that only differ in polarization (e.g., horizontal (H) and vertical (V)), a mode coupler can be any optical element that coherently rotates polarization, e.g., a birefringent material such as a waveplate. For other systems such as ion trap systems or neutral atom systems, a mode coupler can be any physical mechanism that can couple two modes, e.g., a pulsed electromagnetic field that is tuned to couple two internal states of the atom/ion.

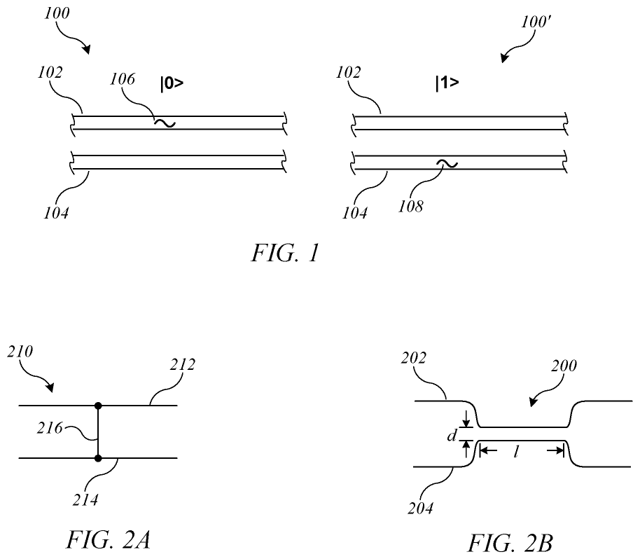

In some embodiments of a photonic quantum computing system using dual-rail encoding, a qubit can be implemented using a pair of waveguides. FIG. 1 shows two representations (100, 100′) of a portion of a pair of waveguides 102, 104 that can be used to provide a dual-rail-encoded photonic qubit. At 100, a photon 106 is in waveguide 102 and no photon is in waveguide 104 (also referred to as a vacuum mode); in some embodiments, this corresponds to the |0 [symbol] state of a photonic qubit. At 100′, a photon 108 is in waveguide 104, and no photon is in waveguide 102; in some embodiments this corresponds to the |1 [symbol] state of the photonic qubit. To prepare a photonic qubit in a known logical state, a photon source (not shown) can be coupled to one end of one of the waveguides. The photon source can be operated to emit a single photon into the waveguide to which it is coupled, thereby preparing a photonic qubit in a known state. Photons travel through the waveguides, and by periodically operating the photon source, a quantum system having qubits whose logical states map to different temporal modes of the photonic system can be created in the same pair of waveguides. In addition, by providing multiple pairs of waveguides, a quantum system having qubits whose logical states correspond to different spatiotemporal modes can be created. It should be understood that the waveguides in such a system need not have any particular spatial relationship to each other. For instance, they can be but need not be arranged in parallel.

Occupied modes can be created by using a photon source to generate a photon that then propagates in the desired waveguide. A photon source can be, for instance, a resonator-based source that emits photon pairs, also referred to as a heralded single photon source. In one example of such a source, the source is driven by a pump, e.g., a light pulse, that is coupled into a system of optical resonators that, through a nonlinear optical process (e.g., spontaneous four wave mixing (SFWM), spontaneous parametric down-conversion (SPDC), second harmonic generation, or the like), can generate a pair of photons. Many different types of photon sources can be employed. Examples of photon pair sources can include a microring-based spontaneous four wave mixing (SPFW) heralded photon source (HPS). However, the precise type of photon source used is not critical and any type of source, employing any process, such as SPFW, SPDC, or any other process can be used. Other classes of sources can also be employed, such as those that employ atomic and/or artificial atomic systems, e.g., quantum dot sources, color centers in crystals, and the like, and sources can incorporate nonlinear optical materials and/or other materials as desired. In some cases, sources may or may not be coupled to photonic cavities, e.g., as can be the case for artificial atomic systems such as quantum dots coupled to cavities. Other types of photon sources also exist for SPWM and SPDC, such as optomechanical systems and the like.

In such cases, operation of the photon source may be non-deterministic (also sometimes referred to as “stochastic”) such that a given pump pulse may or may not produce a photon pair. In some embodiments, coherent spatial and/or temporal multiplexing of several non-deterministic sources (referred to herein as “active” multiplexing) can be used to allow the probability of having one mode become occupied during a given cycle to approach 1. One of ordinary skill will appreciate that many different active multiplexing architectures that incorporate spatial and/or temporal multiplexing are possible. For instance, active multiplexing schemes that employ log-tree, generalized Mach-Zehnder interferometers, multimode interferometers, chained sources, chained sources with dump-the-pump schemes, asymmetric multi-crystal single photon sources, or any other type of active multiplexing architecture can be used. In some embodiments, the photon source can employ an active multiplexing scheme with quantum feedback control and the like.

Measurement operations can be implemented by coupling a waveguide to a single-photon detector that generates a classical signal (e.g., a digital logic signal) indicating that a photon has been detected by the detector. Any type of photodetector that has sensitivity to single photons can be used. In some embodiments, detection of a photon (e.g., at the output end of a waveguide) indicates an occupied mode while absence of a detected photon can indicate an unoccupied mode.

Some embodiments described below relate to physical implementations of unitary transform operations that couple modes of a quantum system, which can be understood as transforming the quantum state of the system. For instance, if the initial state of the quantum system (prior to mode coupling) is one in which one mode is occupied with probability 1 and another mode is unoccupied with probability 1 (e.g., a state |10 [symbol] in the Fock notation introduced above), mode coupling can result in a state in which both modes have a nonzero probability of being occupied, e.g., a state a₁|10 [symbol] +a₂|01 [symbol] , where |a₁|²+|a₂|²=1. In some embodiments, operations of this kind can be implemented by using beam splitters to couple modes together and variable phase shifters to apply phase shifts to one or more modes. The amplitudes a₁ and a₂ depend on the reflectivity (or transmissivity) of the beam splitters and on any phase shifts that are introduced.

FIG. 2A shows a schematic diagram 210 (also referred to as a circuit diagram or circuit notation) for coupling of two modes. The modes are drawn as horizontal lines 212, 214, and the mode coupler 216 is indicated by a vertical line that is terminated with nodes (solid dots) to identify the modes being coupled. In the more specific language of linear quantum optics, the mode coupler 216 shown in FIG. 2A represents a 50/50 beam splitter that implements a transfer matrix:

$$T = \frac{1}{\sqrt{2}} ( \begin{matrix}1 & - i \\ - i & 1\end{matrix} ) , \qquad ( 9 )$$

where T defines the linear map for the photon creation operators on two modes. (In certain contexts, transfer matrix T can be understood as implementing a first-order imaginary Hadamard transform.) By convention the first column of the transfer matrix corresponds to creation operators on the top mode (referred to herein as mode 1, labeled as horizontal line 212), and the second column corresponds to creation operators on the second mode (referred to herein as mode 2, labeled as horizontal line 214), and so on if the system includes more than two modes. More explicitly, the mapping can be written as:

$${( \begin{matrix}{a}_{1}^{†} \\ {a}_{2}^{†}\end{matrix} )}_{input} ↦ \frac{1}{\sqrt{2}} ( \begin{matrix}1 & - i \\ - i & 1\end{matrix} ) {( \begin{matrix}{a}_{1}^{†} \\ {a}_{2}^{†}\end{matrix} )}_{output} , \qquad ( 10 )$$

where subscripts on the creation operators indicate the mode that is operated on, the subscripts input and output identify the form of the creation operators before and after the beam splitter, respectively and where:

$${a}_{i} \vert {n}_{i} , {n}_{j} 〉 = \sqrt{{n}_{i}} \vert {n}_{i} - 1 , {n}_{j} 〉 \qquad ( 11 )$$

$${a}_{j} \vert {n}_{i} , {n}_{j} 〉 = \sqrt{{n}_{j}} \vert {n}_{i} , {n}_{j} - 1 〉$$

$${a}_{i}^{†} \vert {n}_{i} , {n}_{j} 〉 = \sqrt{{n}_{i} + 1} \vert {n}_{i} + 1 , {n}_{j} 〉$$

$${a}_{j}^{†} \vert {n}_{i} , {n}_{j} 〉 = \sqrt{{n}_{j} + 1} \vert {n}_{i} , {n}_{j} + 1 〉$$

For example, the application of the mode coupler shown in FIG. 2A leads to the following mappings:

$${a}_{{1}_{input}}^{†} ↦ \frac{1}{\sqrt{2}} ( {a}_{{1}_{output}}^{†} - {ia}_{{2}_{output}}^{†} ) \qquad ( 12 )$$

$${a}_{{2}_{input}}^{†} ↦ \frac{1}{\sqrt{2}} ( - i {a}_{{1}_{output}}^{†} + {a}_{{2}_{output}}^{†} )$$

Thus, the action of the mode coupler described by Eq. (9) is to take the input states |10 [symbol] , |01 [symbol] , and |11 [symbol] to

$$\vert 10 〉 ↦ \frac{\vert 10 〉 - i \vert 01 〉}{\sqrt{2}} \qquad ( 13 )$$

$$\vert 01 〉 ↦ \frac{- i \vert 10 〉 + \vert 01 〉}{\sqrt{2}}$$

$$\vert 11 〉 ↦ \frac{- i}{2} ( \vert 20 〉 + \vert 02 〉 )$$

FIG. 2B shows a physical implementation of a mode coupling that implements the transfer matrix T of Eq. (9) for two photonic modes in accordance with some embodiments. In this example, the mode coupling is implemented using a waveguide beam splitter 200, also sometimes referred to as a directional coupler or mode coupler. Waveguide beam splitter 200 can be realized by bringing two waveguides 202, 204 into close enough proximity that the evanescent field of one waveguide can couple into the other. By adjusting the separation d between waveguides 202, 204 and/or the length/of the coupling region, different couplings between modes can be obtained. In this manner, a waveguide beam splitter 200 can be configured to have a desired transmissivity. For example, the beam splitter can be engineered to have a transmissivity equal to 0.5 (i.e., a 50/50 beam splitter for implementing the specific form of the transfer matrix T introduced above). If other transfer matrices are desired, the reflectivity (or the transmissivity) can be engineered to be greater than 0.6, greater than 0.7, greater than 0.8, or greater than 0.9 without departing from the scope of the present disclosure.

In addition to mode coupling, some unitary transforms may involve phase shifts applied to one or more modes. In some photonic implementations, variable phase-shifters can be implemented in integrated circuits, providing control over the relative phases of the state of a photon spread over multiple modes. Examples of transfer matrices that define such a phase shifts are given by (for applying a +i and −i phase shift to the second mode, respectively):

$$s = ( \begin{matrix}1 & 0 \\ 0 & i\end{matrix} ) \qquad ( 14 )$$

$${s}^{†} = ( \begin{matrix}1 & 0 \\ 0 & - i\end{matrix} )$$

For silica-on-silicon materials some embodiments implement variable phase-shifters using thermo-optical switches. The thermo-optical switches use resistive elements fabricated on the surface of the chip, that via the thermo-optical effect can provide a change of the refractive index n by raising the temperature of the waveguide by an amount of the order of 10⁻⁵ K. One of skill in the art with access to the present disclosure will understand that any effect that changes the refractive index of a portion of the waveguide can be used to generate a variable, electrically tunable, phase shift. For example, some embodiments use beam splitters based on any material that supports an electro-optic effect, so-called χ² and χ³ materials such as lithium niobite, BBO, KTP, and the like and even doped semiconductors such as silicon, germanium, and the like.

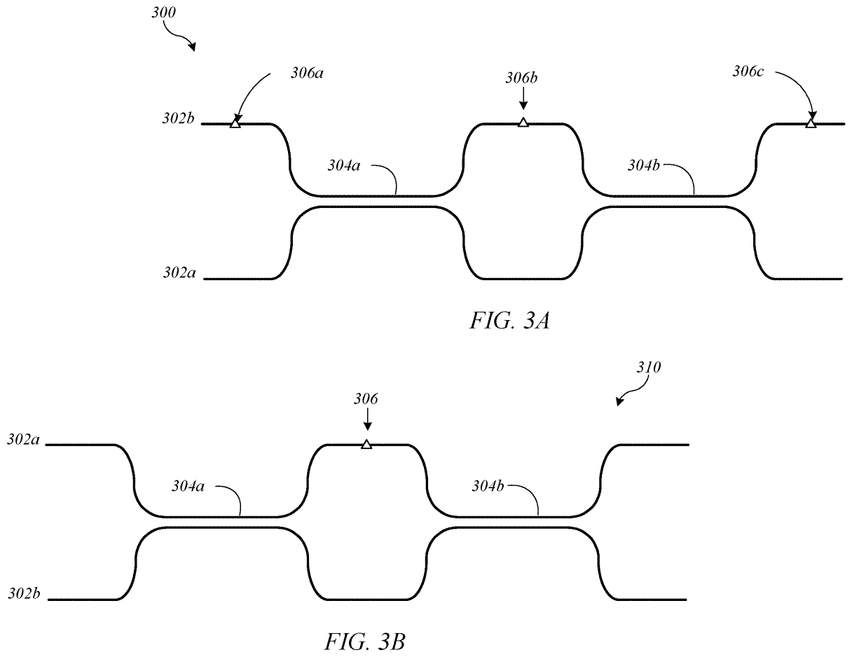

Beam-splitters with variable transmissivity and arbitrary phase relationships between output modes can also be achieved by combining directional couplers and variable phase-shifters in a Mach-Zehnder Interferometer (MZI) configuration 300, e.g., as shown in FIG. 3A. Complete control over the relative phase and amplitude of the two modes 302a, 302b in dual rail encoding can be achieved by varying the phases imparted by phase shifters 306a, 306b, and 306c and the length and proximity of coupling regions 304a and 304b. FIG. 3B shows a slightly simpler example of a MZI 310 that allows for a variable transmissivity between modes 302a, 302b by varying the phase imparted by the phase shifter 306. FIGS. 3A and 3B are examples of how one could implement a mode coupler in a physical device, but any type of mode coupler/beam splitter can be used without departing from the scope of the present disclosure.

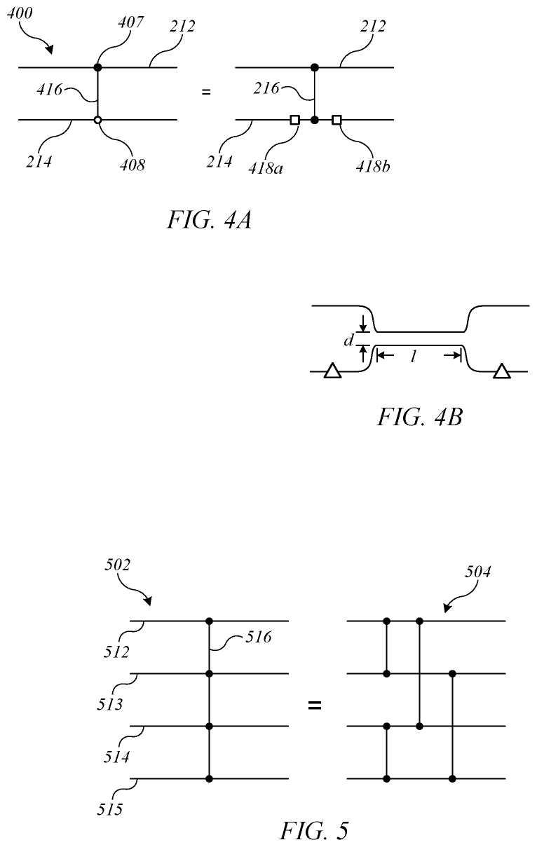

In some embodiments, beam splitters and phase shifters can be employed in combination to implement a variety of transfer matrices. For example, FIG. 4A shows, in a schematic form similar to that of FIG. 2A, a mode coupler 400 implementing the following transfer matrix:

$${T}_{r} = \frac{1}{\sqrt{2}} ( \begin{matrix}1 & 1 \\ 1 & - 1\end{matrix} ) . \qquad ( 15 )$$

Thus, mode coupler 400 applies the following mappings:

$$\vert 10 〉 ↦ \frac{\vert 10 〉 + \vert 01 〉}{\sqrt{2}} \qquad ( 16 )$$

$$\vert 01 〉 ↦ \frac{\vert 10 〉 - \vert 01 〉}{\sqrt{2}}$$

$$\vert 11 〉 ↦ \frac{1}{2} ( \vert 20 〉 + \vert 02 〉 ) .$$

The transfer matrix Tᵣ of Eq. (15) is related to the transfer matrix T of Eq. (9) by a phase shift on the second mode. This is schematically illustrated in FIG. 4A by the closed node 407 where mode coupler 416 couples to the first mode (line 212) and open node 408 where mode coupler 416 couples to the second mode (line 214). More specifically, Tᵣ=sTs, and, as shown at the right-hand side of FIG. 4A, mode coupler 416 can be implemented using mode coupler 216 (as described above), with a preceding and following phase shift (denoted by open squares 418a, 418b). Thus, the transfer matrix Tᵣ can be implemented by the physical beam splitter shown in FIG. 4B, where the open triangles represent +i phase shifters.

Similarly, networks of mode couplers and phase shifters can be used to implement couplings among more than two modes. For example, FIG. 5 shows a four-mode coupling scheme that implements a “spreader,” or “mode-information erasure,” transformation on four modes, i.e., it takes a photon in any one of the input modes and delocalizes the photon amongst each of the four output modes such that the photon has equal probability of being detected in any one of the four output modes. (The well-known Hadamard transformation is one example of a spreader transformation.) As in FIG. 2A, the horizontal lines 512-515 correspond to modes, and the mode coupling is indicated by a vertical line 516 with nodes (dots) to identify the modes being coupled. In this case, four modes are coupled. Circuit notation 502 is an equivalent representation to circuit diagram 504, which is a network of first-order mode couplings. More generally, where a higher-order mode coupling can be implemented as a network of first-order mode couplings, a circuit notation similar to notation 502 (with an appropriate number of modes) may be used.

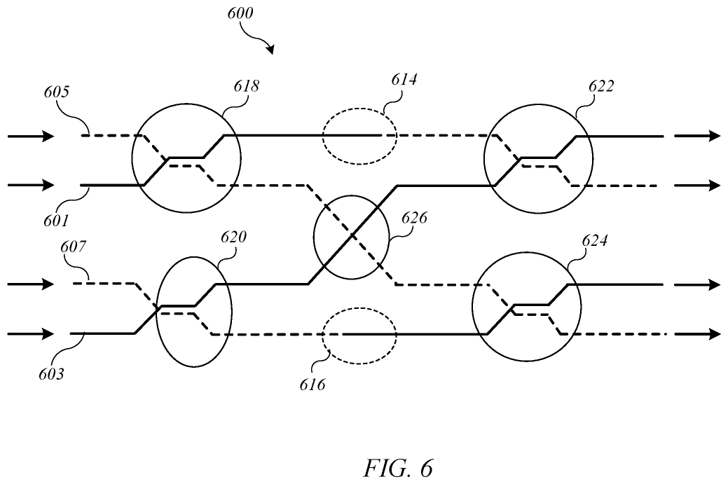

FIG. 6 illustrates an example optical device 600 that can implement the four-mode mode-spreading transform shown schematically in FIG. 5 in accordance with some embodiments. Optical device 600 includes a first set of optical waveguides 601, 603 formed in a first layer of material (represented by solid lines in FIG. 6) and a second set of optical waveguides 605, 607 formed in a second layer of material that is distinct and separate from the first layer of material (represented by dashed lines in FIG. 6). The second layer of material and the first layer of material are located at different heights on a substrate. One of ordinary skill will appreciate that an interferometer such as that shown in FIG. 6 could be implemented in a single layer if appropriate low loss waveguide crossing were employed.

At least one optical waveguide 601, 603 of the first set of optical waveguides is coupled with an optical waveguide 605, 607 of the second set of optical waveguides with any type of suitable optical coupler, e.g., the directional couplers described herein (e.g., the optical couplers shown in FIGS. 2B, 3A, 3B). For example, the optical device shown in FIG. 6 includes four optical couplers 618, 620, 622, and 624. Each optical coupler can have a coupling region in which two waveguides propagate in parallel. Although the two waveguides are illustrated in FIG. 6 as being offset from each other in the coupling region, the two waveguides may be positioned directly above and below each other in the coupling region without offset. In some embodiments, one or more of the optical couplers 618, 620, 622, and 624 are configured to have a coupling efficiency of approximately 50% between the two waveguides (e.g., a coupling efficiency between 49% and 51%, a coupling efficiency between 49.9% and 50.1%, a coupling efficiency between 49.99% and 50.01%, and a coupling efficiency of 50%, etc.). For example, the length of the two waveguides, the refractive indices of the two waveguides, the widths and heights of the two waveguides, the refractive index of the material located between two waveguides, and the distance between the two waveguides are selected to provide the coupling efficiency of 50% between the two waveguides. This allows the optical coupler to operate like a 50/50 beam splitter.

In addition, the optical device shown in FIG. 6 can include two inter-layer optical couplers 614 and 616. Optical coupler 614 allows transfer of light propagating in a waveguide on the first layer of material to a waveguide on the second layer of material, and optical coupler 616 allows transfer of light propagating in a waveguide on the second layer of material to a waveguide on the first layer of material. The optical couplers 614 and 616 allow optical waveguides located in at least two different layers to be used in a multi-channel optical coupler, which, in turn, enables a compact multi-channel optical coupler.

Furthermore, the optical device shown in FIG. 6 includes a non-coupling waveguide crossing region 626. In some implementations, the two waveguides (603 and 605 in this example) cross each other without having a parallel coupling region present at the crossing in the non-coupling waveguide crossing region 626 (e.g., the waveguides can be two straight waveguides that cross each other at a nearly 90-degree angle).

Those skilled in the art will understand that the foregoing examples are illustrative and that photonic circuits using beam splitters and/or phase shifters can be used to implement many different transfer matrices, including transfer matrices for real and imaginary Hadamard transforms of any order, discrete Fourier transforms, and the like. One class of photonic circuits, referred to herein as “spreader” or “mode-information erasure (MIE)” circuits, has the property that if the input is a single photon localized in one input mode, the circuit delocalizes the photon amongst each of a number of output modes such that the photon has equal probability of being detected in any one of the output modes. Examples of spreader or MIE circuits include circuits implementing Hadamard transfer matrices. (It is to be understood that spreader or MIE circuits may receive an input that is not a single photon localized in one input mode, and the behavior of the circuit in such cases depends on the particular transfer matrix implemented.) In other instances, photonic circuits can implement other transfer matrices, including transfer matrices that, for a single photon in one input mode, provide unequal probability of detecting the photon in different output modes.

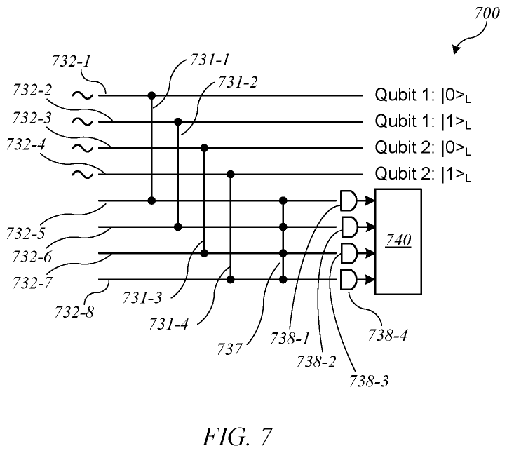

In some embodiments, entangled states of multiple photonic qubits can be created by coupling modes of two (or more) qubits and performing measurements on other modes. By way of example, FIG. 7 shows a circuit diagram for a Bell state generator 700 that can be used in some dual-rail-encoded photonic embodiments. In this example, waveguides (or modes) 732-1 through 732-4 are initially each occupied by a photon (indicated by a wavy line); waveguides (or modes) 732-5 through 732-8 are initially vacuum (unoccupied) modes. (Those skilled in the art will appreciate that other combinations of occupied and unoccupied modes can be used.)

A first-order mode coupling (e.g., implementing transfer matrix T of Eq. (9)) is performed on pairs of occupied and unoccupied modes as shown by mode couplers 731-1 through 731-4, with each mode coupler 731 having one input waveguide receiving a photon and one input waveguide receiving vacuum. Mode couplers 731 can be, e.g., 50/50 beam splitters so that, for example, a photon entering on waveguide 732-1 (or a photon entering on waveguide 732-5) has a 50% probability of emerging on either output of mode coupler 731-1. In the following description, mode couplers 731 may also be referred to as “directional couplers.” Thereafter, a mode-information erasure coupling (e.g., implementing a four-mode mode spreading transform as shown in FIG. 5 or a second-order Hadamard transfer matrix) is performed on one output mode of each directional coupler 731 (in this example, waveguides 733-5 through 733-8 provide inputs to the mode-information erasure coupling), as shown by mode coupler 737. In the following description, mode coupler 737 may also be referred to as a “mode coupler network” or “Hadamard network.” Waveguides 733-5 through 733-8 act as “heralding” modes that are measured and used to determine whether a Bell state was successfully generated on the four output waveguides 733-1 through 733-4. For instance, detectors 738-1 through 738-4 can be coupled to the waveguides 733-5 through 733-8 after second-order mode coupler 737. Each detector 738-1 through 738-4 can output a classical data signal (e.g., a voltage level on a conductor) indicating whether it detected a photon (or the number of photons detected). These outputs can be coupled to classical decision logic circuit 740, which determines whether a Bell state is present on the other four waveguides 733-1 through 733-4. For example, decision logic circuit 740 can be configured such that a Bell state is confirmed (also referred to as “success” of the Bell state generator) if and only if a single photon was detected by each of exactly two of detectors 738-1 through 738-4. In some embodiments, output modes (or waveguides) 733-1 through 733-4 can be mapped to the logical states of two qubits (Qubit 1 and Qubit 2), as indicated in FIG. 7. Specifically, in this example, the logical state of Qubit 1 is based on occupancy of modes 733-1 and 733-2, and the logical state of Qubit 2 is based on occupancy of modes 733-3 and 733-4. It should be noted that generation of a Bell state by Bell state generator 700 is a non-deterministic (or stochastic) process; that is, inputting four photons as shown does not guarantee that a Bell state will be created on modes 733-1 through 733-4. In one implementation, the probability of success is 4/32; in another implementation, the success probability is 3/16. It should also be noted that there are six detection patterns with one photon in each of two of detectors 738, and that Bell state generator 700 can be expected to produce a Bell state in all six possible arrangements of the four output modes. For a given choice of assignment of modes to dual-rail qubits (e.g., as shown in FIG. 7), Bell state generator 700 can produce any of the four two-qubit Bell states defined in Eqs. (3)-(6) above, as well as a “non-qubit” maximally entangled state. Different detection patterns at detectors 738 can correspond to different types of Bell states being produced. In some embodiments, based on the particular detection pattern at detectors 738, mode swaps can be selectably applied to modes 733 in order to cast the Bell state into a particular type (e.g., a particular one of the four two-qubit Bell states defined above). In some embodiments, the mode swap can be subsumed into subsequent operations without the need for active optical switches to implement selectable mode swapping at the output of Bell state generator 700.

In some embodiments, it is desirable to form quantum systems of multiple entangled qubits (two or more qubits). One technique for forming multi-qubit quantum systems is through the use of an entangling measurement, which is a projective measurement that can be employed to create entanglement between systems of qubits. As used herein, “fusion” (or “a fusion operation” or “fusing”) refers to a projective entangling measurement. A “fusion gate” is a structure that receives two (or more) input qubits, each of which is typically part of a different quantum system. Prior to applying the fusion gate, the different quantum systems need not be entangled with each other. In the case of two input qubits, the fusion gate performs a projective measurement operation on the input qubits that produces either one (“type I fusion”) or zero (“type II fusion”) output qubits in a manner such that the initial two quantum systems are fused into a single quantum system of entangled qubits. Fusion gates are specific examples of a general class of projective entangling measurements and are particularly suited for photonic architectures. Examples of type I and type II fusion gates will now be described.

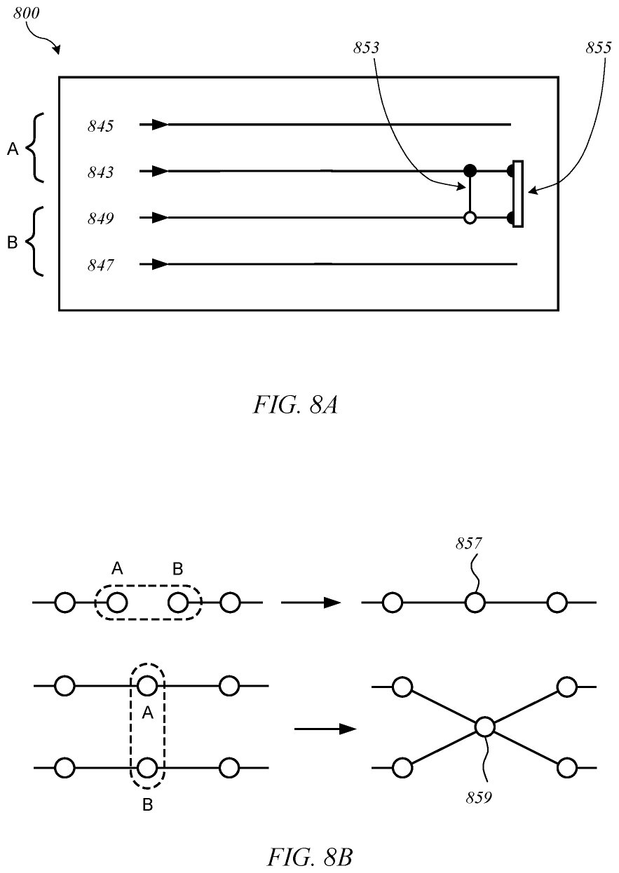

FIG. 8A shows a circuit diagram illustrating a type I fusion gate 800 in accordance with some embodiments. The diagram shown in FIG. 8A is schematic with each horizontal line representing a mode of a quantum system, e.g., a photon. In a dual-rail encoding, each pair of modes represents a qubit. In a photonic implementation of the gate the modes in diagrams such as that shown in FIG. 8A can be physically realized using single photons in photonic waveguides. Most generally, a type I fusion gate like that shown in FIG. 8A takes qubit A (physically realized, e.g., by photon modes 843 and 845) and qubit B (physically realized, e.g., by photon modes 847 and 849) as input and outputs a single “fused” qubit that inherits the entanglement with other qubits that were previously entangled with either (or both) of input qubit A or input qubit B.

For example, FIG. 8B shows the result of type-I fusing of two qubits A and B that are each, respectively, a qubit located at the end (i.e., a leaf) of some longer entangled cluster state (only a portion of which is shown). The qubit 857 that remains after the fusion operation inherits the entangling bonds from the original qubits A and B thereby creating a larger linear cluster state. FIG. 8B also shows the result of type-I fusing of two qubits A and B that are each, respectively, an internal qubit that belongs to some longer entangled cluster of qubits (only a portion of which is shown). As before, the qubit 859 that remains after fusion inherits the entangling bonds from the original qubits A and B thereby creating a fused quantum system. In this case, the qubit that remains after the fusion operation is entangled with the larger quantum system by way of four other nearest neighbor qubits as shown.

Returning to the schematic illustration of type I fusion gate 800 shown in FIG. 8A, qubit A is dual-rail encoded by modes 843 and 845, and qubit B is dual-rail encoded by modes 847 and 849. For example, in the case of path-encoded photonic qubits, the logical zero state of qubit A (denoted |0 [symbol] _{A}) occurs when mode 843 is a photonic waveguide that includes a single photon and mode 845 is a photonic waveguide that includes zero photons (and likewise for qubit B). Thus, type I fusion gate 800 can take as input two dual-rail-encoded photon qubits thereby resulting in a total of four input modes (e.g., modes 843, 845, 847, and 849). To accomplish the fusion operation, a mode coupler (e.g., 50/50 beam splitter) 853 is applied between a mode of each of the input qubits, e.g., between mode 843 and mode 849 before performing a detection operation on both modes using photon detectors 855 (which includes two distinct photon detectors coupled to modes 843 and 849 respectively). If desired, one or more mode swap operations can be applied to position the output modes 845 and 845 adjacent to each other. In some embodiments, mode swapping can be accomplished through a physical waveguide crossing as described above or by one or more photonic switches or by any other type of physical mode swap.

FIG. 8A shows only an example arrangement for a type I fusion gate and one of ordinary skill will appreciate that the position of the mode coupler and the presence of the mode swap region 851 can be altered without departing from the scope of the present disclosure. For example, beam splitter 853 can be applied between modes 845 and 847. Mode swaps are optional and are not necessary if qubits having non-adjacent modes can be dealt with, e.g., by tracking which modes belong to which qubits by storing this information in a classical memory.

Type I fusion gate 800 is a nondeterministic gate, i.e., the fusion operation succeeds with a certain probability less than 1, and in other cases the quantum state that results is not a larger quantum system that comprises the original quantum systems fused together to form a larger quantum system. More specifically, gate 800 “succeeds,” with probability 50%, when only one photon is detected by detectors 855, and “fails” if zero or two photons are detected by detectors 855. When the gate succeeds, the two quantum systems that qubits A and B were a part of become fused into a single larger quantum system with a fused qubit remaining as the qubit that links the two previously unlinked quantum systems (see, e.g., FIG. 8B). However, when the fusion gate fails, it has the effect of removing both qubits from the original quantum systems without generating a larger quantum system.

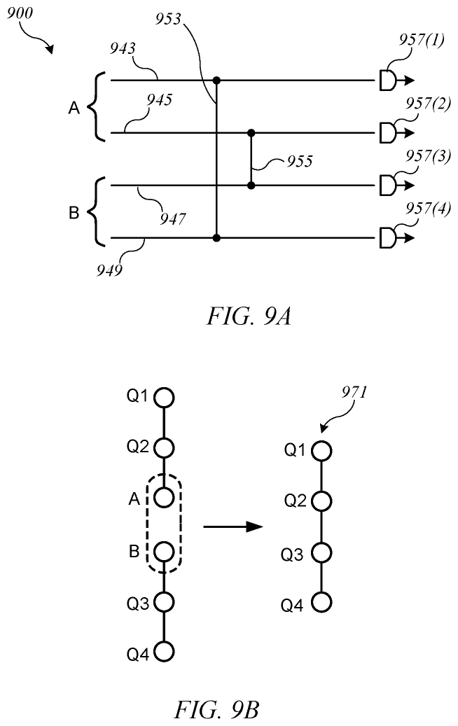

FIG. 9A shows a circuit diagram illustrating a type II fusion gate 900 in accordance with some embodiments. Like other diagrams herein, the diagram shown in FIG. 9A is schematic with each horizontal line representing a mode of a quantum system, e.g., a photon. In a dual-rail encoding, each pair of modes represents a qubit. In a photonic implementation of the gate the modes in diagrams such as that shown in FIG. 9A can be physically realized using single photons in photonic waveguides. Most generally, a type II fusion gate such as gate 900 takes qubit A (physically realized, e.g., by photon modes 943 and 945) and qubit B (physically realized, e.g., by photon modes 947 and 949) as input and outputs a quantum state that inherits the entanglement with other qubits that were previously entangled with either (or both) of input qubit A or input qubit B. (For type II fusion, if the input quantum states had a total of N qubits between them, the output quantum state has N−2 qubits. This is different from type I fusion where input quantum states having a total of N qubits between them leads to an output quantum state having N−1 qubits.)

For example, FIG. 9B shows the result of type-II fusing of two qubits A and B that are each, respectively, a qubit located at the end (i.e., a leaf) of some longer entangled cluster state (only a portion of which is shown). The resulting quantum system 971 inherits the entangling bonds from qubits A and B thereby creating a larger linear quantum system.

Returning to the schematic illustration of type II fusion gate 900 shown in FIG. 9A, qubit A is dual-rail encoded by modes 943 and 945, and qubit B is dual-rail encoded by modes 947 and 949. For example, in the case of path encoded photonic qubits, the logical zero state of qubit A (denoted |0 [symbol] _{A}) occurs when mode 943 is a photonic waveguide that includes a single photon and mode 945 is a photonic waveguide that includes zero photons (and likewise for qubit B). Thus, type II fusion gate 900 takes as input two dual-rail-encoded photon qubits thereby resulting in a total of four input modes (e.g., modes 943, 945, 947, and 949). To accomplish the fusion operation, a first mode coupler (e.g., 50/50 beam splitter) 953 is applied between a mode of each of the input qubits, e.g., between mode 943 and mode 949, and a second mode coupler (e.g., 50/50 beam splitter) 955 is applied between the other modes of each of the input qubits, e.g., between modes 945 and 947. A detection operation is performed on all four modes using photon detectors 957(1)-957(4). In some embodiments, mode swap operations (not shown in FIG. 9A) can be performed to place modes in adjacent positions prior to mode coupling. In some embodiments, mode swapping can be accomplished through a physical waveguide crossing as described above or by one or more photonic switches or by any other type of physical mode swap. Mode swaps are optional and are not necessary if qubits having non-adjacent modes can be dealt with, e.g., by tracking which modes belong to which qubits by storing this information in a classical memory.

FIG. 9A shows only an example arrangement for the type II fusion gate and one of ordinary skill will appreciate that the positions of the mode couplers and the presence or absence of mode swap regions can be altered without departing from the scope of the present disclosure.

The type II fusion gate shown in FIG. 9A is a nondeterministic gate, i.e., the fusion operation succeeds with a certain probability less than 1, and in other cases the quantum state that results is not a larger quantum system that comprises the original quantum systems fused together to a larger quantum system. More specifically, the gate “succeeds” in the case where one photon is detected by one of detectors 957(1) and 957(4) and one photon is detected by one of detectors 957(2) and 957(3); in all other cases, the gate “fails.” When the gate succeeds, the two quantum systems that qubits A and B were a part of become fused into a single larger quantum system; unlike type-I fusion, no fused qubit remains (compare FIG. 8B and FIG. 9B). When the fusion gate fails, it has the effect of removing both qubits from the original quantum systems without generating a larger quantum system.

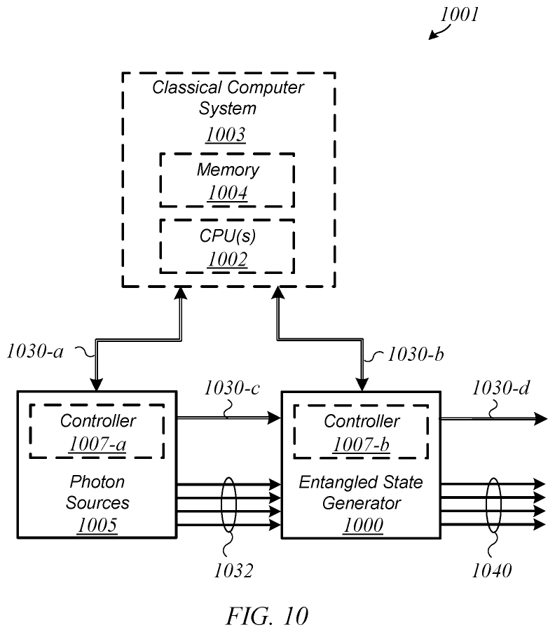

FIG. 10 illustrates an example of a qubit entangling system 1001 in accordance with some embodiments. Such a system can be used to generate qubits (e.g., photons) in an entangled state (e.g., a GHZ state, Bell pair, and the like), in accordance with some embodiments. In some embodiments, qubit entangling system 1001 can operate as a resource state generator as described below.

In an illustrative photonic architecture, qubit entangling system 1001 can include a photon source module 1005 that is optically connected to entangled state generator 1000. Both the photon source module 1005 and the entangled state generator 1000 may be coupled to a classical processing system 1003 such that the classical processing system 1003 can communicate and/or control (e.g., via the classical information channels 1030a-b) the photon source module 1005 and/or the entangled state generator 1000. Photon source module 1005 may include a collection of single-photon sources that can provide output photons to entangled state generator 1000 by way of interconnecting waveguides 1032. Entangled state generator 1000 may receive the output photons and convert them to one or more entangled photonic states and then output these entangled photonic states into output waveguides 1040. In some embodiments, output waveguide 1040 can be coupled to some downstream quantum photonic circuit that may use the entangled states, e.g., for performing a quantum computation. For example, the entangled states generated by the entangled state generator 1000 may be used as resource states for one or more interleaving modules as described below.

In some embodiments, system 1001 may include classical channels 1030 (e.g., classical channels 1030-a through 1030-d) for interconnecting and providing classical information between components. It should be noted that classical channels 1030-a through 1030-d need not all be the same. For example, classical channel 1030-a through 1030-c may comprise a bi-directional communication bus carrying one or more reference signals, e.g., one or more clock signals, one or more control signals, or any other signal that carries classical information, e.g., heralding signals, photon detector readout signals, and the like.

In some embodiments, qubit entangling system 1001 includes the classical computer system 1003 that communicates with and/or controls the photon source module 1005 and/or the entangled state generator 1000. For example, in some embodiments, classical computer system 1003 can be used to configure one or more circuits, e.g., using a system clock that may be provided to photon sources 1005 and entangled state generator 1000 as well as any downstream quantum photonic circuits used for performing quantum computation. In some embodiments, the quantum photonic circuits can include optical circuits, electrical circuits, or any other types of circuits. In some embodiments, classical computer system 1003 includes memory 1004, one or more processor(s) 1002, a power supply, an input/output (I/O) subsystem, and a communication bus or interconnecting these components. The processor(s) 1002 may execute modules, programs, and/or instructions stored in memory 1004 and thereby perform processing operations.

In some embodiments, memory 1004 stores one or more programs (e.g., sets of instructions) and/or data structures. For example, in some embodiments, entangled state generator 1000 can attempt to produce an entangled state over successive stages, any one of which may be successful in producing an entangled state. In some embodiments, memory 1004 stores one or more programs for determining whether a respective stage was successful and configuring the entangled state generator 1000 accordingly (e.g., by configuring entangled state generator 1000 to switch the photons to an output if the stage was successful, or pass the photons to the next stage of the entangled state generator 1000 if the stage was not yet successful). To that end, in some embodiments, memory 1004 stores detection patterns (described below) from which the classical computing system 1003 may determine whether a stage was successful. In addition, memory 1004 can store settings that are provided to the various configurable components (e.g., switches) described herein that are configured by, e.g., setting one or more phase shifts for the component.

In some embodiments, some or all of the above-described functions may be implemented with hardware circuits on photon source module 1005 and/or entangled state generator 1000. For example, in some embodiments, photon source module 1005 includes one or more controllers 1007-a (e.g., logic controllers) (e.g., which may comprise field programmable gate arrays (FPGAs), application specific integrated circuits (ASICS), a “system on a chip” that includes classical processors and memory, or the like). In some embodiments, controller 1007-a determines whether photon source module 1005 was successful (e.g., for a given attempt on a given clock cycle, described below) and outputs a reference signal indicating whether photon source module 1005 was successful. For example, in some embodiments, controller 1007-a outputs a logical high value to classical channel 1030-a and/or classical channel 1030-c when photon source module 1005 is successful and outputs a logical low value to classical channel 1030-a and/or classical channel 1030-c when photon source module 1005 is not successful. In some embodiments, the output of control 1007-a may be used to configure hardware in controller 1007-b.

Similarly, in some embodiments, entangled state generator 1000 includes one or more controllers 1007-b (e.g., logical controllers) (e.g., which may comprise field programmable gate arrays (FPGAs), application specific integrated circuits (ASICS), or the like) that determine whether a respective stage of entangled state generator 1000 has succeeded, perform the switching logic described above, and output a reference signal to classical channels 1030-b and/or 1030-d to inform other components as to whether the entangled state generator 400 has succeeded.

In some embodiments, a system clock signal can be provided to photon source module 1005 and entangled state generator 1000 via an external source (not shown) or by classical computing system 1003 generates via classical channels 1030-a and/or 1030-b. In some embodiments, the system clock signal provided to photon source module 1005 triggers photon source module 1005 to attempt to output one photon per waveguide. In some embodiments, the system clock signal provided to entangled state generator 1000 triggers, or gates, sets of detectors in entangled state generator 1000 to attempt to detect photons. For example, in some embodiments, triggering a set of detectors in entangled state generator 1000 to attempt to detect photons includes gating the set of detectors.

It should be noted that, in some embodiments, photon source module 1005 and entangled state generator 1000 may have internal clocks. For example, photon source module 1005 may have an internal clock generated and/or used by controller 1007-a and entangled state generator 1000 has an internal clock generated and/or used by controller 1007-b. In some embodiments, the internal clock of photon source module 1005 and/or entangled state generator 1000 is synchronized to an external clock (e.g., the system clock provided by classical computer system 1003) (e.g., through a phase-locked loop). In some embodiments, any of the internal clocks may themselves be used as the system clock, e.g., an internal clock of the photon source may be distributed to other components in the system and used as the master/system clock.

In some embodiments, photon source module 1005 includes a plurality of probabilistic photon sources that may be spatially and/or temporally multiplexed, i.e., a so-called multiplexed single photon source. In one example of such a source, the source is driven by a pump, e.g., a light pulse, that is coupled into an optical resonator that, through some nonlinear process (e.g., spontaneous four wave mixing, second harmonic generation, and the like) may generate zero, one, or more photons. As used herein, the term “attempt” is used to refer to the act of driving a photon source with some sort of driving signal, e.g., a pump pulse, that may produce output photons non-deterministically (i.e., in response to the driving signal, the probability that the photon source will generate one or more photons may be less than 1). In some embodiments, a respective photon source may be most likely to, on a respective attempt, produce zero photons (e.g., there may be a 90% probability of producing zero photons per attempt to produce a single-photon). The second most likely result for an attempt may be production of a single-photon (e.g., there may be a 9% probability of producing a single-photon per attempt to produce a single-photon). The third most likely result for an attempt may be production of two photons (e.g., there may be an approximately 1% probability of producing two photons per attempt to produce a single photon). In some circumstances, there may be less than a 1% probability of producing more than two photons.

In some embodiments, the apparent efficiency of the photon sources may be increased by using a plurality of single-photon sources and multiplexing the outputs of the plurality of photon sources.

The precise type of photon source used is not critical and any type of source can be used, employing any photon generating process, such as spontaneous four wave mixing (SPFW), spontaneous parametric down-conversion (SPDC), or any other process. Other classes of sources that do not necessarily require a nonlinear material can also be employed, such as those that employ atomic and/or artificial atomic systems, e.g., quantum dot sources, color centers in crystals, and the like. In some cases, sources may or may be coupled to photonic cavities, e.g., as can be the case for artificial atomic systems such as quantum dots coupled to cavities. Other types of photon sources also exist for SPWM and SPDC, such as optomechanical systems and the like. In some examples the photon sources can emit multiple photons already in an entangled state in which case the entangled state generator 400 may not be necessary, or alternatively may take the entangled states as input and generate even larger entangled states.

For the sake of illustration, an example which employs spatial multiplexing of several non-deterministic photon sources is described as an example of a MUX photon source. However, many different spatial MUX architectures are possible without departing from the scope of the present disclosure. Temporal MUXing can also be implemented instead of or in combination with spatial multiplexing. MUX schemes that employ log-tree, generalized Mach-Zehnder interferometers, multimode interferometers, chained sources, chained sources with dump-the-pump schemes, asymmetric multi-crystal single photon sources, or any other type of MUX architecture can be used. In some embodiments, the photon source can employ a MUX scheme with quantum feedback control and the like.

The foregoing description provides an example of how photonic circuits can be used to implement physical qubits and operations on physical qubits using mode coupling between waveguides. In these examples, a pair of modes can be used to represent each physical qubit. Examples described below can be implemented using similar photonic circuit elements.

In some embodiments, an entangled system of multiple physical qubits can be mapped to one or more “logical qubits,” and operations associated with a quantum computation can be defined as logical operations on logical qubits, which in turn can be mapped to physical operations on physical qubits. In general, the term “qubit,” when used herein without specifying physical or logical qubit, should be understood as referring to a physical qubit.

### 2. Multiplexing Entanglement Generators

### 2.1. Bell State Generators Using Paired Photon Sources

Referring to FIG. 7, when directional coupler 731-1 (or any other directional coupler 731) receives one photon (or occupied mode) and one vacuum mode, directional coupler 731-1 can output the photon in either output mode with equal probability. Accordingly, any combination of inputs in which each of directional couplers 731-1 through 731-4 receives one photon and one vacuum mode can result in production of a Bell state. In embodiments where photons are provided using heralded single photon sources (examples of which are described above), each successful photon production event produces two photons, referred to herein as “signal” and “herald” photons. Where the photons are to be used to generate Bell states, directional coupling can be applied to the herald photons. Examples of Bell state generator circuits based on this technique will now be described.

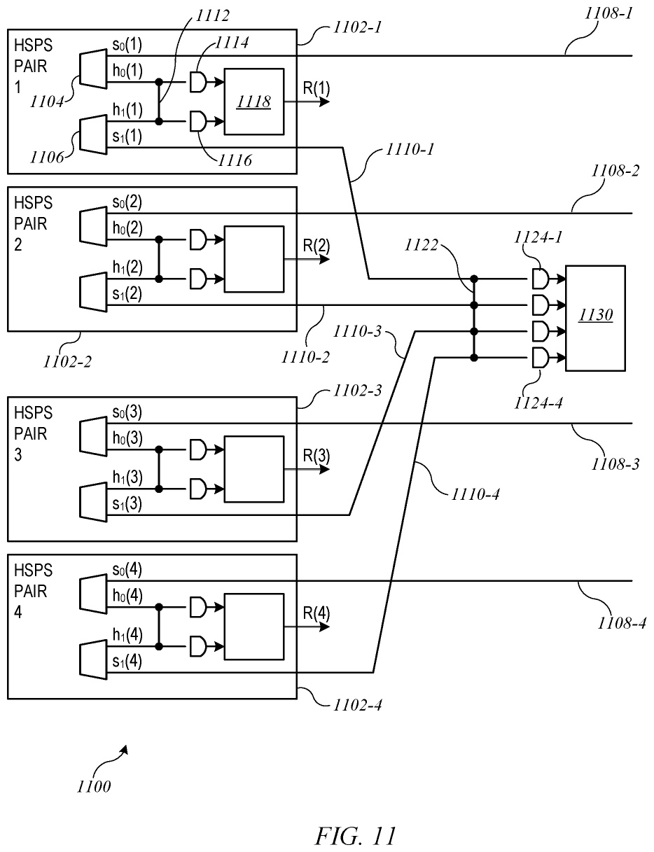

FIG. 11 shows a simplified schematic diagram of a Bell state generator (BSG) circuit 1100 according to some embodiments. Circuit 1100 can be an optical circuit through which photons propagate and can be implemented using components described above. Circuit 1100 can include set of four heralded single photon source (HSPS) pairs 1102-1 through 1102-4. Each HSPS pair has two output optical paths 1108, 1110 (e.g., waveguides) that can propagate photons. As shown for HSPS pair 1102-1, each HSPS pair includes two heralded single photon sources 1104, 1106. Heralded single photon source 1104 produces a signal photon s₀(1) that propagates on output path 1108-1 and a herald photon h₀(1). Heralded single photon source 1102 produces a signal photon s₁(1) that propagates on output path 1110-1 and a herald photon h₁(1). Although not expressly shown, in some implementations of a heralded single photon source, the signal and herald photons may be initially produced in the same spatial mode but with different polarizations and/or different frequencies. In such implementations, the photons can be directed onto different output paths or waveguides using appropriate optical components (e.g., beam splitters). Accordingly, a heralded single photon source such as source 1104 or 1106 can include all optical components that participate in producing a pair of photons and directing the photons into a pair of output paths or waveguides. A first-order mode coupling (e.g., implementing transfer matrix T of Eq. (9)) is performed on herald photons h₀(1) and h₁(1), as shown by mode coupler 1112. Detectors 1114, 1116 are coupled to the outputs of mode coupler 1112. Each detector 1114, 1116 can output a classical data signal (e.g., a voltage level on a conductor) indicating whether it detected a photon (or the number of photons detected). The classical data signal output of detectors 1114, 1116 can be coupled to a classical decision logic circuit 1118, which determines whether HSPS pair 1102-1 produced a “success” state or “failure” state on output paths 1108-1 and 1110-1. In some embodiments, decision logic circuit 1118 can output a classical result signal R(1) indicating whether the output state of HSPS pair 1102-1 is a success state or a failure state. In examples herein, a “success” state for HSPS pair 1102-1 refers to a state in which a photon is present on one of output paths 1108-1 or 1110-1 and a vacuum mode is present on the other of output paths 1108-1 or 1110-1, and in which no determination has been made as to which of output paths 1108-1 or 1110-1 has the photon; other states are referred to as “failure” states. For example, assuming that sources 1104, 1106 each produce either a pair of photons or no photons, it can be inferred that if a herald photon h₀(1) is present, then a signal photon s₀(1) is also present; likewise, if a herald photon h₁(1) is present, then a signal photon s₁(1) is also present. Accordingly, if exactly one of detectors 1114, 1116 detects a photon, it can be inferred that either s₀(1) or s₁(1) (but not both) is present. Due to mode coupler 1112, decision logic 1118 does not have information to distinguish between a success state |10 [symbol] (s₀(1) is present; s₁(1) is not) and a success state |01 [symbol] (s₁(1) is present; s₀(1) is not). Thus, the success state on modes 1108-1 and 1110-1 is the same as the state that would exist on the outputs of mode coupler 731-1 in FIG. 7. Accordingly, mode coupling between output paths 1108-1 and 1110-1 can be omitted. HSPS pairs 1102-2 through 1102-4 can be configured similarly or identically to HSPS pair 1102-1.

For Bell state generation, HSPS pair output paths 1110-1 through 1110-4 can be coupled to a 4×4 mode coupler network 1122. Mode coupler network 1122 can implement a mode-information erasure (MIE) coupling, such as a four-mode mode spreading transform as shown in FIG. 5 or a second-order Hadamard transfer matrix. In the following description, mode coupler network 1122 and similar networks may be referred to as a “mode coupler network” or “Hadamard network.” Outputs of mode coupler network 1122 can be coupled to detectors 1124-1 through 1124-4. Each detector 1124-1 through 1124-4 can output a classical data signal (e.g., a voltage level on a conductor) indicating whether it detected a photon (or the number of photons detected). These classical data signal outputs can be coupled to classical decision logic circuit 1130, which can determine whether a Bell state is present on the other four output paths 1108-1 through 1108-4. For example, decision logic circuit 1130 can be configured such that a Bell state is confirmed (also referred to as “success” of the Bell state generator) if and only if a single photon was detected by each of exactly two of detectors 1124-1 through 1124-4. The logic can be the same as the logic implemented in decision logic 740 of Bell state generator 700 described above, and the same Bell states as described above can be produced. (If desired, decision logic circuit 1130 can also receive classical result signals R(1) through R(4) and verify success of the HSPS pairs.) In some embodiments, the probability of success for circuit 1100 is comparable to the probability of success for circuit 700.

One difference between Bell state generator 700 and Bell state generator 1100 is that the signal output paths 1108 of Bell state generator 1100 do not pass through any mode coupling devices, unlike signal output paths 732-1 through 732-4 of Bell state generator 700. This may improve transmission efficiency.

It should also be noted that different photons in circuit 1100 can have different frequencies, as long as photons that interfere with each other (e.g., in mode coupler 1108 or mode coupler network 1122) have the same frequency. For example, circuit 1100 uses interference between the h₀ and h₁ photons in a given HSPS pair 1102 and interference between s₁ photons generated by different HSPS pairs 1102. The s₁ photons are consumed by detectors 1124, so interference between s₁ and so photons is not used; nor is interference between any signal photon (s₀ or s₁) and any herald photon (h₀ or h₁). Accordingly, in some embodiments, photon source 1104 can produce so photons at a first frequency and h₀ photons at a second frequency that is different from the first frequency. Similarly, photon source 1106 can produce h₁ photons at the second frequency and s₁ photons at a third frequency that can be different from either the first or second frequency. In some embodiments, the s₁ and so photons can have the same frequency as each other, which can be the same as or different from the frequency of the h₀ and h₁ photons.

2.2. Bell State Generators with Incorporated Multiplexing

As with circuit 700, one challenge for circuit 1100 is that known single-photon sources operate non-deterministically, and a given photon source may or may not produce a photon pair in response to a given pump pulse. Thus, the probability that all four of HSPS pairs 1102 of Bell state generator 1100 succeed during a given operating cycle may be small, which limits the probability of successfully generating a Bell state. In some embodiments, the probability of successfully generating a Bell state can be increased by providing additional HSPS pairs and performing multiplexing or switching operations on the s₁ outputs.

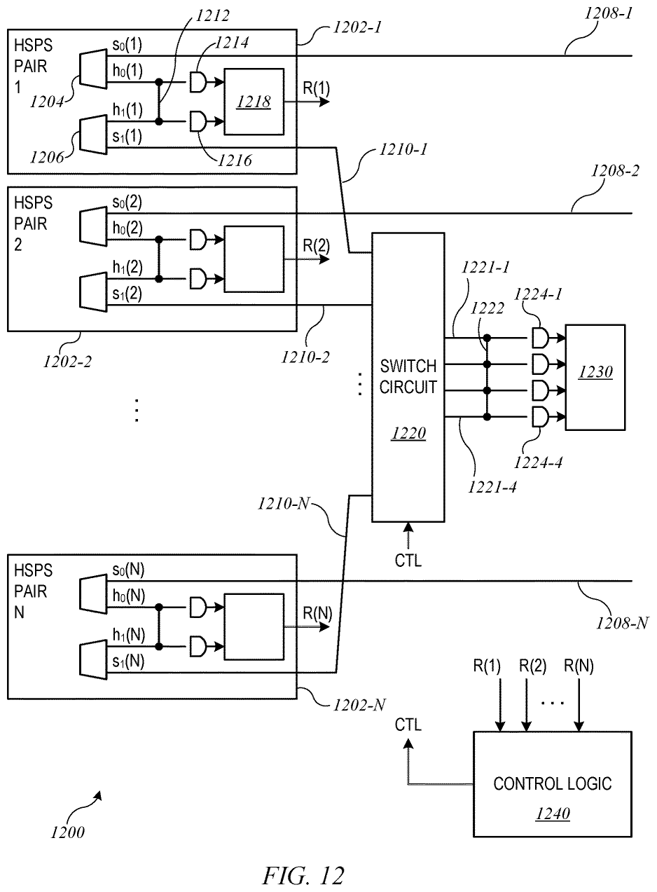

FIG. 12 shows a simplified schematic diagram of a Bell state generator (BSG) circuit 1200 according to some embodiments. Circuit 1200 can be an optical circuit through which photons propagate and can be implemented using components described above. Circuit 1200 differs from circuit 1100 in that the number of HSPS pairs is increased, and a switching circuit 1220 is provided to select four successful HSPS pairs to use for generating the Bell state. Circuit 1200 can include a number (N) of HSPS pairs 1202-1 through 1202-N. Each HSPS pair 1202 has two output optical paths 1208, 1210 that can propagate photons. Each HSPS pair 1202 can be implemented in the same manner as HSPS pairs 1102 described above. In particular, as shown for HSPS pair 1202-1, each HSPS pair includes two heralded single photon sources 1204, 1206. Heralded single photon source 1204 produces a signal photon s₀(1) that propagates on output path 1208-1 and a herald photon h₀(1). Heralded single photon source 1102 produces a signal photon s₁(1) that propagates on output path 1210-1 and a herald photon h₁(1). A first-order mode coupling (e.g., implementing transfer matrix T of Eq. (9)) is performed on herald photons h₀(1) and h₁(1), as shown by mode coupler 1212. Detectors 1214, 1216 are coupled to the outputs of mode coupler 1212. Each detector 1214, 1216 can output a classical data signal (e.g., a voltage level on a conductor) indicating whether it detected a photon (or the number of photons detected). The classical data signal outputs of detectors 1214, 1216 can be coupled to a classical decision logic circuit 1218, which can determine whether HSPS pair 1202-1 produced a success state or failure state on output paths 1208-1 and 1210-1. In some embodiments, decision logic circuit 1218 can output a classical result signal R(1) indicating whether the output state of HSPS pair 1202-1 is a success state or a failure state. For example, as described above, a success state for HSPS pair 1202-1 can be defined as a state in which exactly one photon is detected by detectors 1214, 1216, which indicates that one photon is present on one of output paths 1208-1 or 1210-1 and a vacuum mode is present on the other of output paths 1208-1 or 1210-1, without determining which of output paths 1208-1 or 1210-1 has the photon. HSPS pairs 1202-2 through 1202-N can be configured similarly or identically to HSPS pair 1202-1.

For Bell state generation, HSPS pair output paths 1210-1 through 1210-N can be coupled to a switch circuit 1220 that has four output paths 1221-1 through 1221-4. Switch circuit 1220 can include a network of optical switches, including active switches, that can selectably couple four of the input paths 1210-1 through 1210-N to output paths 1221-1 through 1221-4. Example implementations of switch circuit 1220 are described below. Operation of switch circuit 1220 can be controlled by classical control logic circuit 1240. Classical control logic circuit 1240 (and other classical logic circuits described herein) can be implemented using a microprocessor, microcontroller, field programmable gate array (FPGA), application-specific integrated circuit (ASIC) or any other digital logic circuitry. In some embodiments, classical control logic circuit 1240 can be integrated into a photonic/electronic circuit that also includes switch circuit 1220. In other embodiments, classical control logic circuit 1240 can be implemented in a separate device, and in some embodiments the separate device may be a classical computer system that can include a programmable processor and other supporting components. In operation, classical control logic circuit 1240 can receive the classical result signals R(1) through R(N) from HSPS pairs 1202-1 through 1202-N. Based on the pattern of the classical result signals, classical control logic circuit 1240 can select a set of four HSPS pairs that produced success states from among HSPS pairs 1202-1 through 1202-N and can generate control signals (CTL) to set the state of the active switches in switch circuit 1220 such that the signal path 1210-i of each HSPS pair 1202-i in the selected set is optically coupled to one of the output paths 1221-1 through 1221-4. In some embodiments, a lookup table can be used to map different combinations of classical result signals R(1) through R(N) to corresponding combinations of active switch settings that effect the desired optical coupling.

Output paths 1221-1 through 1221-4 can be coupled to the input paths of a 4×4 mode coupler network 1222, which can be similar or identical to mode coupler network 1122 described above. Outputs of mode coupler network 1122 can be coupled to detectors 1224-1 through 1224-4, which can be similar or identical to detectors 1124-1 through 1124-4 described above. Classical data signals output from detectors 1224-1 through 1224-4 can be coupled to classical decision logic circuit 1230, which can determine whether a Bell state is present on four of the output paths 1208-1 through 1208-N. The configuration and operation of classical decision logic circuit 1230 can be similar or identical to classical decision logic circuit 1130 described above.

In this manner, circuit 1200 can produce a Bell state on four of output paths 1208-1 through 1208-N. More specifically, the Bell state is produced on the four output paths 1208-i from the set of four HSPS pairs 1202-i selected by classical control logic 1240. Other (“non-selected”) output paths 1208-j may or may not carry photons. In some embodiments, blocking switches can be included on output paths 1208-1 through 1208-N and used to ensure that non-selected output paths do not propagate stray photons into downstream optical components. (Examples of blocking switches are described below.) In some embodiments, classical control logic circuit 1240 can provide an output signal indicating which four HSPS pairs 1202 were selected. This output signal can be used by downstream circuits; a particular use of output signals is not relevant to understanding the present disclosure.

Circuit 1200 can produce the same Bell states as circuit 1100. As with circuit 1100, output paths 1208 of circuit 1200 need not pass through any mode coupling devices. The absence of mode coupling devices may improve transmission efficiency. Where the single photon sources are non-deterministic sources, circuit 1200 provides an increased probability of success as compared to circuit 1100 by increasing the number of HSPS pairs (and therefore the number of attempts at generating photons in a given cycle). The number N of HSPS pairs can be selected as desired, and for large enough N the probability of generating a photon in each of (at least) four HSPS pairs can approach 1.

In some embodiments, switch circuit 1220 can be a full N×4 multiplexing switch, in which any combination of four input paths 1210 can be optically coupled to the output paths 1221. This option provides maximum flexibility in selecting inputs, with the tradeoff being a large switching network in which photons pass through multiple active switches. (The number of active switches through which photons pass is referred to herein as the “switch depth.”) In other embodiments, simpler switch circuits can be provided.

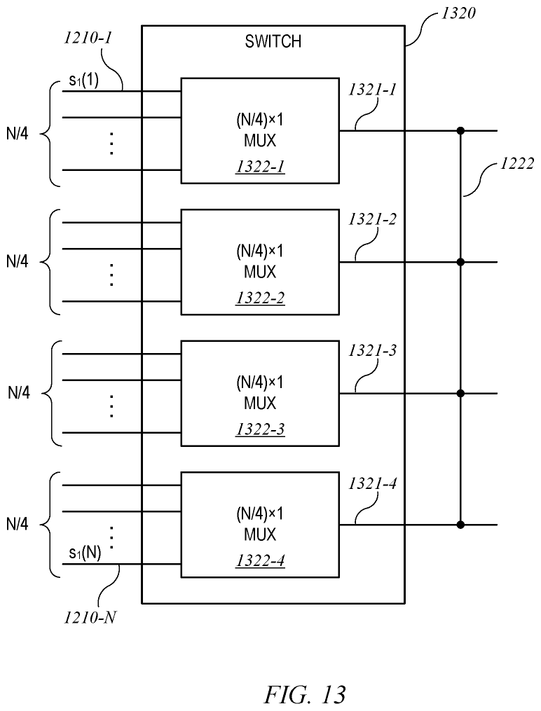

FIG. 13 shows a simplified schematic diagram of a switch circuit 1320 that can be used to implement switch circuit 1220 in some embodiments. Switch circuit 1320 includes a set of four (N/4)×1 multiplexing (mux) circuits 1322-1 through 1322-4. Each mux circuit 1322 can be coupled to a different subset of the input paths 1210 such that each mux circuit 1322 is coupled to (N/4) of the input paths 1210. Each mux circuit 1322 has one output path 1321 and one or more active optical switches (not explicitly shown) arranged to selectably create an optical coupling between any one of the N/4 input paths 1210 and the output path 1321. Since there are four mux circuits 1322, switch circuit 1320 has four output paths 1321-1 through 1321-4. As shown, output paths 1321-1 through 1321-4 can be coupled to mode coupling network 1222 as described above with reference to FIG. 12. As long as (at least) one HSPS pair 1202 in each group of (N/4) HSPS pairs coupled to the same mux circuit 1322-i succeeds, control logic 1240 can select a state for switch circuit 1320 such that a Bell state can be produced.

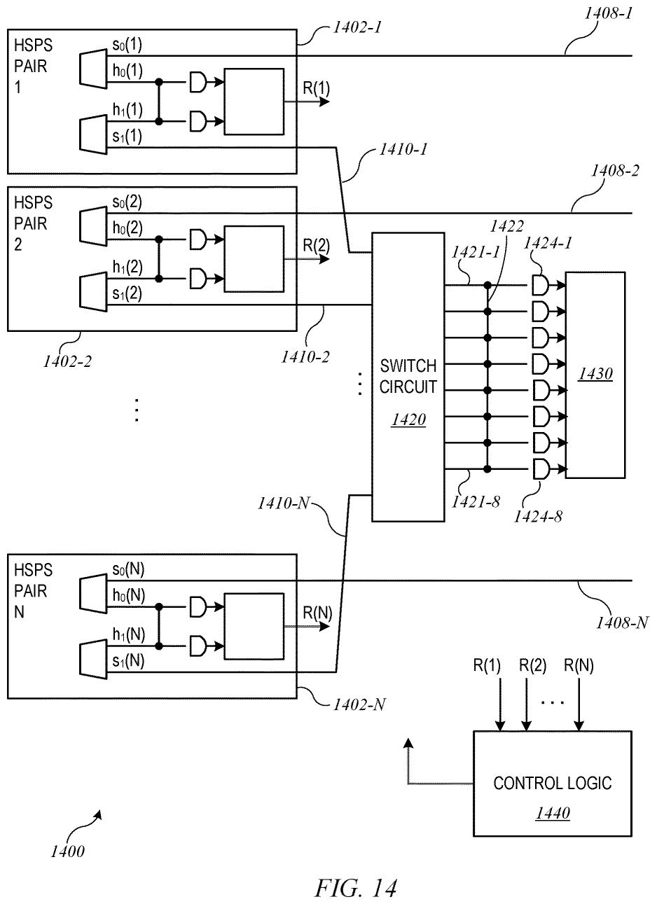

In some embodiments, the complexity of switch circuit 1220 can be reduced by enlarging the size of the mode coupler network. FIG. 14 shows a simplified schematic diagram of a Bell state generator (BSG) circuit 1400 according to some embodiments. Circuit 1400 can be an optical circuit through which photons propagate and can be implemented using components described above. Circuit 1400 differs from circuit 1200 in that the number of input and output modes of the mode coupler network 1422 and the number of detectors 1424 downstream of the mode coupler network is increased. Circuit 1400 can include a number (N) of HSPS pairs 1402-1 through 1402-N. The number N can be chosen as desired, provided that Nis at least equal to the number of input modes of mode coupler network 1422. In this example, mode coupler network 1422 has eight input modes, and accordingly N can be greater than or equal to eight. Each HSPS pair 1402 can have two output optical paths 1408, 1410 that can propagate photons. Each HSPS pair 1402 can be implemented in the same manner as HSPS pairs 1102 described above.

For Bell state generation, HSPS pair output paths 1410-1 through 1410-N can be coupled to a switch circuit 1420 that has eight output paths 1421-1 through 1421-8. Switch circuit 1420 can include a network of optical switches, including active switches, that can selectably couple eight of the input paths 1410-1 through 1410-N to output paths 1421-1 through 1421-N. Example implementations of switch circuit 1420 are described below. Operation of switch circuit 1420 can be controlled by classical control logic circuit 1440. Classical control logic circuit 1440 can be implemented similarly to classical control logic circuit 1240 described above. In operation, classical control logic circuit 1440 can receive the classical result signals R(1) through R(N) from HSPS pairs 1402-1 through 1402-N. Based on the pattern of the classical result signals, control logic 1240 can select a set of four HSPS pairs that produced the success state from among HSPS pairs 1402-1 through 1402-N and can generate control signals (CTL) to set the state of the active switches in switch circuit 1420 such that the signal path 1410-i of each selected HSPS pair 1402-i becomes optically coupled to one of the output paths 1421-1 through 1421-8. The selection of particular output paths can depend on the combination of selected HSPS pairs. For a given choice of N, switch circuit 1420 may have a lower switch depth than switch circuit 1220 while still supporting most or all combinations of selected HSPS pairs. In some embodiments, switch circuit 1420 can include blocking switches on each output path 1421-1 through 1421-8, and output paths 1421 that are not optically coupled to any of the four selected input paths 1410 can be dumped to vacuum (e.g., using blocking switches as described below) so that stray photons do not affect operation of mode coupler network 1422.

Output paths 1421-1 through 1421-8 can be coupled to the input paths of an 8×8 mode coupler network 1422, which can be similar to mode coupler networks described above. For example, mode coupler network 1422 can implement a mode information erasure coupling such as a third-order Hadamard transfer matrix (also referred to as an “8-Hadamard”) or other eight-mode mode spreading transform. Outputs of mode coupler network 1422 can be coupled to detectors 1424-1 through 1424-8, which can be similar or identical to detectors 1124-1 through 1124-4 described above. Classical data signals output from detectors 1424-1 through 1424-8 can be coupled to classical decision logic circuit 1430, which can determine whether a Bell state is present on four of the output paths 1408-1 through 1408-N. The configuration and operation of classical decision logic circuit 1430 can be similar or identical to classical decision logic circuit 1230 described above.

In this manner, circuit 1400 can produce a Bell state on four of output paths 1408-1 through 1408-N. More specifically, the Bell state is produced on the four output paths 1408-i that correspond to the four HSPS pairs 1402-i selected by classical control logic 1440. Other (“non-selected”) output paths 1408-j may or may not carry photons. In some embodiments, blocking switches can be included on output paths 1408-1 through 1408-N and used to ensure that non-selected output paths do not propagate stray photons into downstream optical components.

Circuit 1400 can produce the same Bell states as circuit 1100 or circuit 1200. As with circuits 1100 and 1200, output paths 1408 of circuit 1400 need not pass through any mode coupling devices, unlike signal output paths 732-1 through 732-4 of Bell state generator 700. This may improve transmission efficiency. Where the single photon sources are non-deterministic sources, circuit 1400 provides an increased probability of success as compared to circuit 1100 by increasing the number of sources (and therefore the number of attempts at generating photons in a given cycle). The number N of HSPS pairs can be selected as desired, and for large enough N the probability of generating a photon in each of (at least) four HSPS pairs can approach 1. As compared to circuit 1200, circuit 1400 can provide a simpler active switch circuit with lower switch depth, which may improve transmission efficiency. A design tradeoff is the increased size of mode coupler network 1422 relative to mode coupler network 1222; however, mode coupler network 1422 can be implemented using only passive optical components with negligible transmission loss.

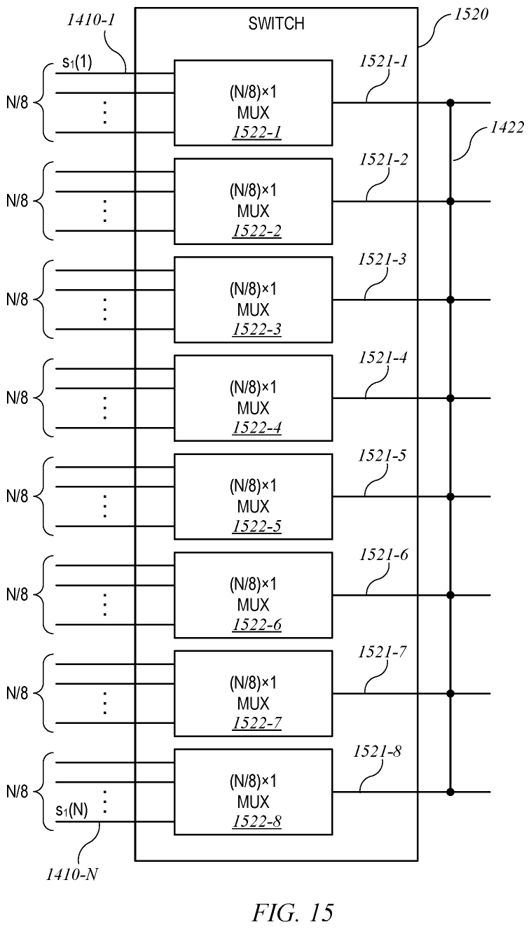

As with circuit 1200, switch circuit 1420 can have a variety of configurations, including a full N×8 switch that supports any combination of selected inputs. In some embodiments, switch depth can be reduced. By way of example, FIG. 15 shows a simplified schematic diagram of a switch circuit 1520 that can be used to implement switch circuit 1420 in some embodiments. Switch circuit 1520 includes a set of eight (N/8)×1 multiplexing (mux) circuits 1522-1 through 1522-8. Each mux circuit 1522 can be coupled to a different subset of the input paths 1410 such that each mux circuit 1522 is coupled to (N/8) of the input paths 1410. Each mux circuit 1522 has one output path 1521 and one or more active optical switches (not explicitly shown) arranged to selectably create an optical coupling between any one of the N/8 input paths 1410 and the output path 1521. It should be noted that for a given N, using (N/8)×1 mux circuits 1522 can result in an optical path with fewer active switches than using (N/4)×1 mux circuits 1322, which can reduce photon loss. Since there are eight mux circuits 1522, switch circuit 1520 has eight output paths 1521-1 through 1521-8. As shown, output paths 1521-1 through 1521-4 can be coupled to mode coupling network 1422 as described above with reference to FIG. 14. As long as (at least) one HSPS pair 1402 in each group of (N/8) HSPS pairs coupled to the same mux circuit 1522-i succeeds, control logic 1440 can select a state for switch circuit 1520 such that a Bell state can be produced. Given a set of N HSPS pairs, switch circuit 1520 allows a larger number of combinations of successful HSPS pairs to have outputs routed to different mux circuits 1522, as compared to switch circuit 1320.

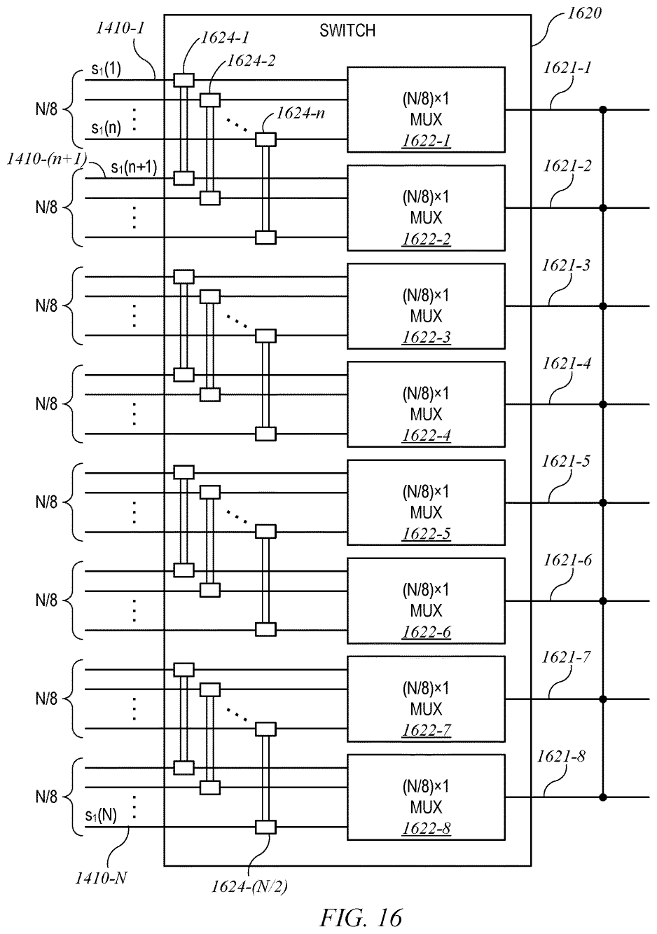

FIG. 16 shows a simplified schematic diagram of another switch circuit 1620 that can be used to implement switch circuit 1420 in some embodiments. Switch circuit 1620 includes a set of eight (N/8)×1 multiplexing (mux) circuits 1622-1 through 1622-8, similarly to switch circuit 1520. Switch circuit 1620 also includes a set of (N/2) 2×2 mux circuits 1624-1 through 1624-(N/2). Each 2×2 mux circuit 1624 can be an optical switch that selectably couples each input path to either output path such that the inputs are either passed through or swapped at the outputs. Thus, for example, mux circuit 1624-1 can receive s₁(1) on input path 1410-1 and s₁(n+1) on input path 1410-(n+1), where n=N/8. In the passthrough state, s₁(1) is propagated to mux 1622-1 and s₁(n+1) is propagated to mux 1622-2; in the swap state, s₁(n+1) is propagated to mux 1622-1 and s₁(1) is propagated to mux 1622-2. Each mux circuit 1622 has one output path 1621 and one or more active optical switches (not explicitly shown) arranged to selectably create an optical coupling between any one of the N/8 input paths and the output path 1621 As shown, output paths 1621-1 through 1621-8 can be coupled to mode coupling network 1422 as described above with reference to FIG. 14. Control logic 1440 (shown in FIG. 14) can control (N/8)×1 mux circuits 1622-1 through 1622-8 and 2×2 mux circuits 1624-1 through 1624-(N/2) to deliver the s₁ outputs of four HSPS pairs that succeeded to mode coupler network 1422. As compared to switch circuit 1520, switch circuit 1640 can increase the number of combinations of successful HSPS pairs from which four s₁ outputs can be delivered to mode coupler network 1422. For instance, if HSPS pairs 1402-1 and 1402-2 both succeeded while none of HSPS pairs 1402-(n+1) through 1402-(n+8) succeeded, 2×2 mux circuits 1624-1 and 1624-2 can be operated to pass through s₁(1) to (N/8)×1 mux 1622-1 and switch s₁(2) to (N/8)×1 mux 1622-2.

It should be understood that switch circuits 1520 and 1620 are illustrative and that a variety of different switch circuits can be used in circuit 1400. It should also be understood that 2×2 mux circuits similar to circuits 1624 can also be used in an analogous manner in switch circuit 1320 of FIG. 13.

As can be seen from FIGS. 15 and 13, for a given number N of HSPS pairs, using a larger mode coupler network (8×8 mode coupler network 1522 as compared to 4×4 mode coupler network 1322) can reduce the complexity of the switch network used to select inputs to the mode coupler network. Since active optical switches generally have higher loss than passive mode couplers, enlarging the mode coupler network and reducing the complexity of the switch network can reduce optical loss. In various embodiments, the size of the mode coupler network can be chosen as desired; for instance any size from four to N (the number of HSPS pairs) can be chosen.

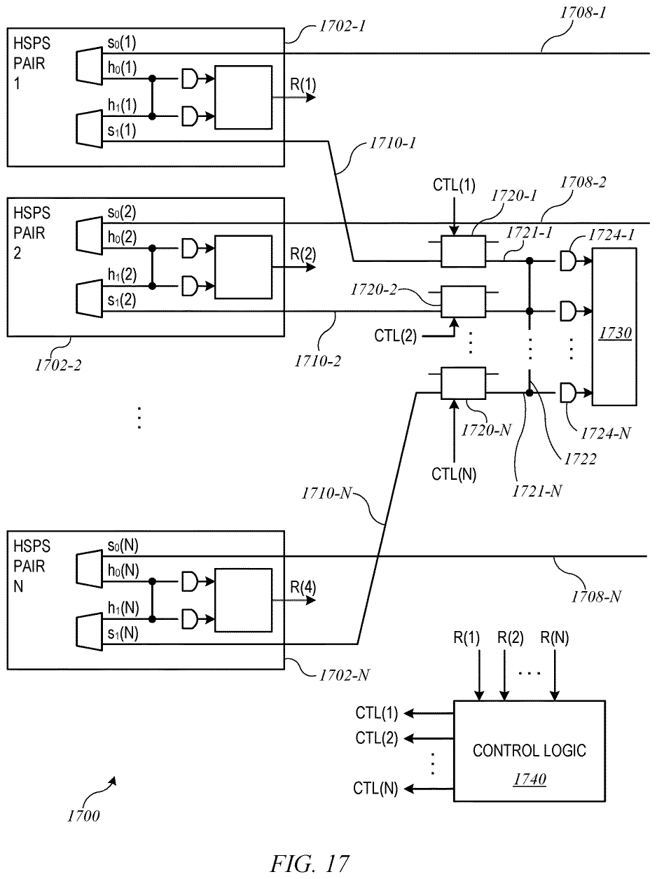

In some embodiments, the active switching network can be omitted entirely. FIG. 17 shows a simplified schematic diagram of a Bell state generator (BSG) circuit 1700 according to some embodiments. Circuit 1700 can be an optical circuit through which photons propagate and can be implemented using components described above. Circuit 1700 differs from circuit 1400 in that the number of input and output modes of the mode coupler network 1722 and the number of detectors 1724 downstream of mode coupler network 1722 is equal to the number of HSPS pairs, and no switch circuit is used. Circuit 1700 can include a number (N) of HSPS pairs 1702-1 through 1702-N. The number N can be chosen as desired, provided that Nis at least four. (In the N=4 case, circuit 1700 can be the same as circuit 1100.) Each HSPS pair 1702 can have two output optical paths 1708, 1710 that can propagate photons. Each HSPS pair 1702 can be implemented in the same manner as HSPS pairs 1102 described above.

For Bell state generation, HSPS pair output paths 1710-1 through 1710-N can each be coupled to one of a set of blocking switches 1720-1 through 1720-N. Each blocking switch 1720 can be implemented as a 2×2 optical switch with one input path and one output path coupled to vacuum (e.g., a waveguide with a truncated end). Based on the state of a control signal (CTL (i)), blocking switch 1720 can be in either a pass-through state in which input path 1710 is optically coupled to output path 1721 or a blocking state in which the vacuum input path is optically coupled to output path 1721 and input path 1710 is optically coupled to the vacuum output path. Operation of blocking switches 1720 can be controlled by classical control logic circuit 1740. Classical control logic circuit 1740 can be implemented similarly to classical control logic circuit 1240 described above. In operation, classical control logic circuit 1740 can receive the classical result signals R(1) through R(N) from HSPS pairs 1702-1 through 1702-N. Based on the pattern of the classical result signals, control logic 1740 can select four HSPS pairs that succeeded from among HSPS pairs 1702-1 through 1702-N and can generate control signals (CTL) to set the state of the blocking switches 1720-1 through 1720-N such that four HSPS pairs 1702-i that succeeded have blocking switches 1720-i in the pass-through state and the other blocking switches 1720-j are in the blocking state. In instances where more than four HSPS pairs 1702 succeeded, the selection of four blocking switches to place in the pass-through state can be based on the particular combination of HSPS pairs that succeeded, as some combinations may produce Bell states with higher probability than other combinations.

Output paths 1721-1 through 1721-N can be coupled to the input paths of an N×N mode coupler network 1722, which can be similar to mode coupler networks described above. For example, mode coupler network 1722 can implement a mode information erasure coupling such as a (log₂ N)-order Hadamard transfer matrix (also referred to as an “N-Hadamard”) or other N-mode mode spreading transform. Outputs of mode coupler network 1722 can be coupled to detectors 1724-1 through 1724-N, which can be similar or identical to detectors 1124-1 through 1124-4 described above. Classical data signals output from detectors 1724-1 through 1724-N can be coupled to classical decision logic circuit 1730, which can determine whether a Bell state is present on four of the output paths 1708-1 through 1708-N. The configuration and operation of classical decision logic circuit 1730 can be similar or identical to classical decision logic circuit 1430 described above.

In this manner, circuit 1700 can produce a Bell state on four of output paths 1708-1 through 1708-N. More specifically, the Bell state is produced on the four output paths 1708-i that correspond to the output paths 1710-i selected by classical control logic 1740. Other (“non-selected”) output paths 1708-j may or may not carry photons. In some embodiments, blocking switches can be included on output paths 1708-1 through 1708-N and used to ensure that non-selected output paths do not propagate stray photons into downstream optical components.

Circuit 1700 can produce the same Bell states as circuit 1100, circuit 1200, or circuit 1400. As with circuits 1100, 1200, and 1400, output paths 1708 of circuit 1700 need not pass through any mode coupling devices, unlike signal output paths 732-1 through 732-4 of Bell state generator 700. This may improve transmission efficiency. Where the single photon sources are non-deterministic sources, circuit 1700 provides an increased probability of success as compared to circuit 1100 by increasing the number of sources (and therefore the number of attempts at generating photons in a given cycle). The number N of HSPS pairs can be selected as desired, and for large enough N the probability of generating a photon in each of (at least) four HSPS pairs can approach 1. As compared to circuits 1200 and 1400, circuit 1700 can further reduce the number of active switches prior to mode coupler network 1722. In some embodiments, blocking switches 1720 can be omitted. For instance, if the probability that more than four HSPS pairs succeed in a given operating cycle is sufficiently low, the blocking switches can be omitted. Signals R(1) through R(N) can be used by decision logic 1730 to determine whether a Bell state was produced; for instance, in an operating cycle for which more or fewer than four HSPS pairs signal success, decision logic 1730 can report failure.

2.3. n-GHZ State Generators

The previous sections describe examples of Bell state generator circuits that produce an entangled state between two qubits. According to some embodiments, similar circuits can be used to generate larger entangled states, i.e., entangled states involving more than two qubits. One category of such states includes n-GHZ states as defined above with reference to Eq. (7). An n-GHZ state can be constructed for any number (n) of qubits, where nis at least equal to 2. (The n=2 case corresponds to a Bell state.)

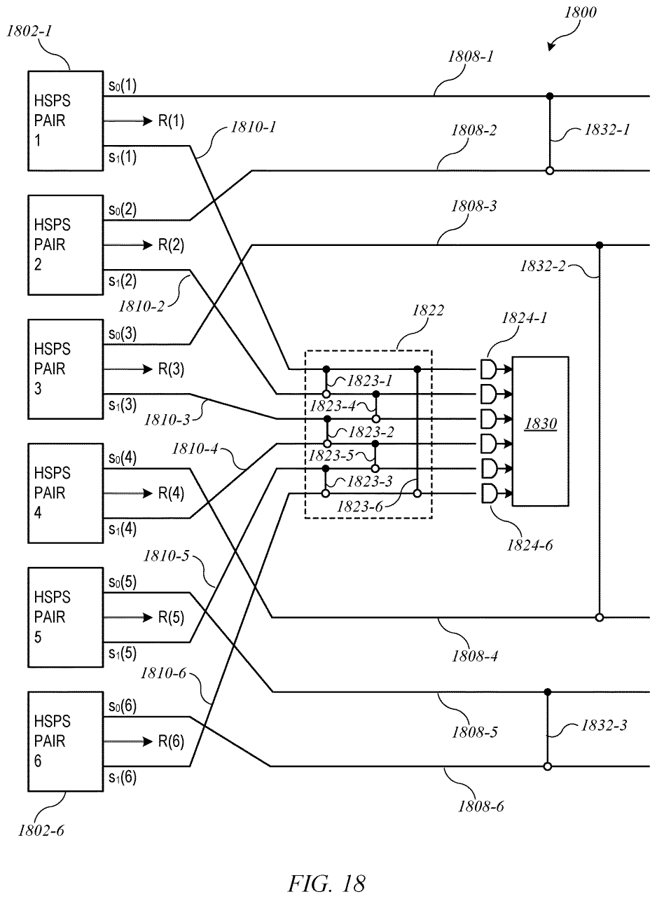

FIG. 18 shows a simplified schematic diagram of a 3-GHZ state generator circuit 1800 according to some embodiments. Circuit 1800 can be an optical circuit through which photons propagate and can be implemented using components described above. Circuit 1800 can include six heralded single photon source (HSPS) pairs 1802-1 through 1802-6. Each HSPS pair 1802-i (for index i from 1 to 6) has two output optical paths 1808-i, 1810-i (e.g., waveguides) that can propagate photons and a classical result output R(i). The construction and operation of each HSPS pair 1802-i can be similar to HSPS pair 1102-1 described above, and internal details are not shown in FIG. 18. For instance, each HSPS pair 1802-i can include two heralded single photon sources, a mode coupler operating on the herald photons, detectors to detect the herald photons, and classical decision logic to generate the classical result signal R(i) indicating whether the output state of HSPS pair 1802-i is a success state or a failure state. The decision logic can be as described above, with the success state of signal R(i) indicating that one or the other (but not both) of photons s₀(i) or s₁(i) is present on output paths 1808-i, 1810-i.

For 3-GHZ state generation, HSPS pair output paths 1810-1 thorough 1810-6 (one output path from each HSPS pair) can be coupled to a mode coupler network 1822. Mode coupler network 1822 can implement a mode information erasure coupling on its input modes 1810-1 through 1810-6. In the example shown, beam splitters 1823-1 through 1823-3 each operate on a different pair of modes, after which beam splitters 1823-4 through 1823-6 operate on neighboring modes that were not previously paired. (As shown, the outermost modes are treated as neighboring and operated on by beam splitter 1823-6.) In this example, beam splitters 1823-1 through 1823-6 incorporate phase shifts to implement a real-valued transform (as described above with reference to FIG. 4A); such phase shifts are optional and can be modified or omitted. Other implementations of mode coupler network 1822 or mode information erasure can also be used. Outputs of mode coupler network 1822 can be coupled to detectors 1824-1 through 1824-6. Each detector 1824 is coupled to one of the output modes and can output a classical data signal (e.g., a voltage level on a conductor) indicating whether it detected a photon (or the number of photons detected). These classical data signal outputs can be coupled to classical decision logic circuit 1830, which can use the data signals to determine whether a 3-GHZ state is present on the other six output paths 1808-1 through 1808-6.

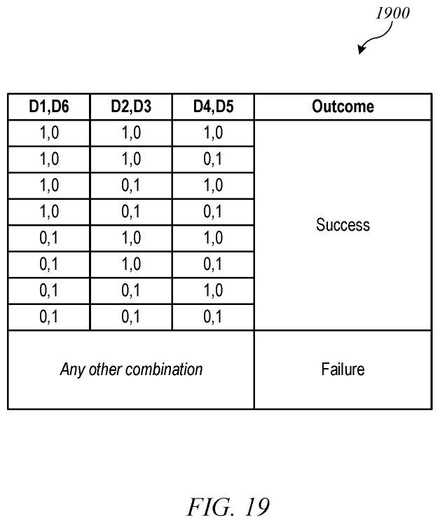

FIG. 19 shows an example of a truth table 1900 that can be implemented in decision logic circuit 1830 according to some embodiments. D1, D2, D3, D4, D5, and D6 indicate the number of photons detected by detectors 1824-1 through 1824-6, respectively. In truth table 1900, the detector outputs are considered in pairs (D1, D6), (D2, D3), and (D4, D5). If each pair reports exactly one photon, then a 3-GHZ state is confirmed (also referred to as “success” of the 3-GHZ state generator). In all other cases, a 3-GHZ state is not confirmed (also referred to as “failure” of the 3-GHZ state generator). It should be understood that the truth table for a given embodiment depends on the particular configuration of the mode coupler network applied upstream of the detectors. The example shown in table 1900 is applicable to the arrangement of beam splitters 1823-1 through 1823-6 shown in FIG. 18. As with the Bell states of Eqs. (3)-(6) above, there are multiple 3-GHZ states, which differ in the relative phases of the qubits. In some embodiments, different successful detection patterns (e.g., different rows in truth table 1900) can correspond to different 3-GHZ states, and the output of decision logic circuit 1830 can indicate which 3-GHZ state was generated.

In some embodiments, HSPS pair output paths 1808-1 through 1808-6 (the paths that provide three dual-rail encoded qubits in the 3-GHZ state) can be coupled in pairs by mode couplers 1832-1 through 1832-3. For instance, mode coupler 1832-1 can couple output paths 1808-1 and 1808-2; mode coupler 1832-2 can couple output paths 1808-3 and 1808-4; and mode coupler 1832-3 can couple output paths 1808-5 and 1808-6. Mode coupler 1832-1 through 1832-3 can be used to effect a basis change, if a basis change is desired, or they can be omitted without affecting operation of mode coupler network 1822 or decision logic 1830.

As with the Bell state generator circuits described above, different photons in circuit 1800 can have different frequencies, as long as photons that interfere with each other (e.g., in mode couplers within the HSPS pairs, in mode coupler network 1822, or in mode couplers 1832-1 through 1832-3) have the same frequency. For example, circuit 1800 uses interference between the herald photons in a given HSPS pair 1802, interference between so photons generated by different HSPS pairs 1802, and interference between s₁ photons generated by different HSPS pairs 1102. The s₁ photons are consumed by detectors 1824, so interference between s₁ and so photons is not used; nor is interference between any signal photon (s₀ or s₁) and any herald photon. Accordingly, in some embodiments, the photon sources can produce so photons at a first frequency and herald photons at a second frequency that is different from the first frequency. In some embodiments, the s₁ and so photons can have the same frequency as each other, which can be the same as or different from the frequency of the herald photons.

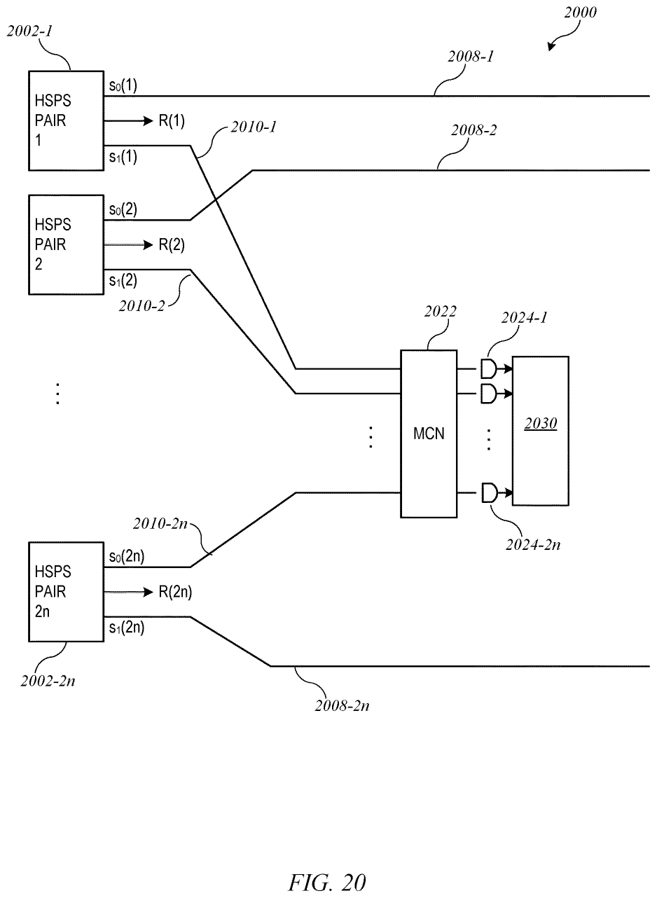

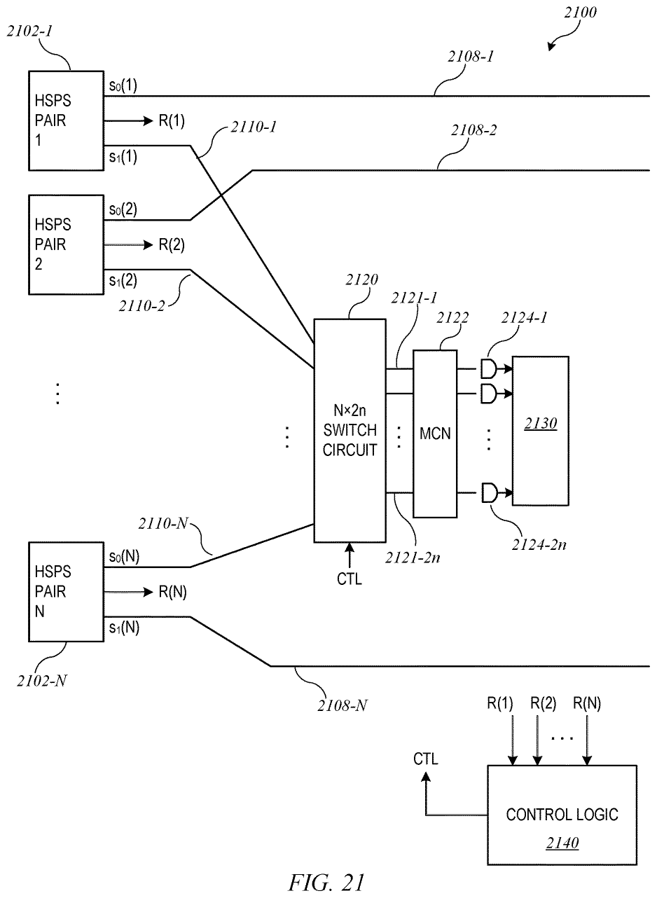

The 3-GHZ generator circuit of FIG. 18 can be generalized to larger n-GHZ states by providing a set of 2n HPSPS pairs and an appropriate mode coupler network, detectors, and detection logic. FIG. 20 shows a simplified schematic diagram of an n-GHZ state generator circuit 2000 according to some embodiments. Circuit 2000 can be an optical circuit through which photons propagate and can be implemented using components described above. Circuit 2000 can include a number (2n) of HSPS pairs 2002-1 through 2002-2n. The size parameter n can be selected to match the number of qubits in the output n-GHZ state. In general, n can be any integer greater than or equal to 2; where n=2, circuit 2000 corresponds to Bell state generator circuit 1100 described above, and where n=3, circuit 2000 corresponds to 3-GHZ state generator circuit 1800 described above. Each HSPS pair 2002-i (for index i from 1 to 2n) has two output optical paths 2008-i, 2010-i (e.g., waveguides) that can propagate photons and a classical result output R(i). The construction and operation of each HSPS pair 2002-i can be similar to HSPS pair 1102-1 described above, and internal details are not shown in FIG. 20. For instance, each HSPS pair 2002-i can include two heralded single photon sources, a mode coupler operating on the herald photons, detectors to detect the herald photons, and classical decision logic to generate the classical result signal R(i) indicating whether the output state of HSPS pair 2002-i is a success state or a failure state. The decision logic can be as described above, with the success state of signal R(i) indicating that one or the other (but not both) of photons s₀(i) or s₁(i) is present on output paths 2008-i, 2010-i.

For n-GHZ state generation, HSPS pair output paths 2010-1 thorough 2010-2n (one output path from each HSPS pair 2002-i) can be coupled to a mode coupler network (MCN) 2022 having 2n inputs and 2n outputs. Mode coupler network 2022 can implement a mode information erasure coupling on its input modes 2010-1 through 2010-2n. In some embodiments, the mode coupler network can be implemented analogously to mode coupler network 1822 in FIG. 18. Specifically, a first group of beam splitters can couple adjacent pairs of modes (analogous to beam splitters 1823-1 through 1823-3), after which a second group of beam splitters can couple neighboring pairs of modes that were not previously coupled (analogous to beam splitters 1823-4 and 1824-5) and an additional beam splitter can couple the first and last modes (analogous to beam splitter 1823-6). The number of beam splitters in each group increases with n. Other arrangements of beam splitters that preserve the total number of photons while erasing information as to which input mode(s) carried photons can be substituted. Outputs of mode coupler network 2022 can be coupled to detectors 2024-1 through 2024-2n. Each detector 2024 is coupled to one of the 2n output modes of mode coupler network 2022 and can output a classical data signal (e.g., a voltage level on a conductor) indicating whether it detected a photon (or the number of photons detected). These classical data signal outputs can be coupled to classical decision logic circuit 2030, which can determine whether a n-GHZ state is present on the other 2n output paths 2008-1 through 2008-2n. For a mode coupler network 2022 implemented analogously to mode coupler network 1822 in FIG. 18, decision logic circuit 2030 can implement a truth table that follows the same principle described above for the 3-GHZ case: detector outputs are paired, and success or failure is determined based on whether each pair of detectors detected exactly one photon. In some embodiments, different successful detection patterns can correspond to different n-GHZ states, and the output of decision logic circuit 1830 can indicate which n-GHZ state was generated

According to some embodiments, multiplexing of HSPS pairs can be incorporated into an n-GHZ generator circuit, e.g., by providing a number N of HSPS pairs (where N>2n) and switch circuits upstream of the mode coupler network. FIG. 21 shows a simplified schematic diagram of an n-GHZ circuit 2100 according to some embodiments. Circuit 2100 can be an optical circuit through which photons propagate and can be implemented using components described above. Circuit 2100 differs from circuit 2000 in that the number of HSPS pairs is increased to a number larger than 2n and a switching circuit 2120 is provided upstream of the mode coupler network to select 2n successful HSPS pairs to use for generating the n-GHZ state. Circuit 2100 can include a number (N) of HSPS pairs 2102-1 through 2102-N, where Nis greater than 2n and n is the number of qubits in the target n-GHZ state.) Each HSPS pair 2102-i (where index i ranges from 1 to N) has two output optical paths 2108-i, 2110-i that can propagate photons. The construction and operation of each HSPS pair 2102-i can be similar to HSPS pair 1102-1 described above, and internal details are not shown in FIG. 21. For instance, each HSPS pair 2102-i can include two heralded single photon sources, a mode coupler operating on the herald photons, detectors to detect the herald photons, and classical decision logic to generate the classical result signal R(i) indicating whether the output state of HSPS pair 2102-i is a success state or a failure state. The decision logic can be as described above, with the success state of signal R(i) indicating that one or the other (but not both) of photons s₀(i) or s₁(i) is present on output paths 2108-i, 2110-i.

For n-GHZ state generation, HSPS pair outputs 2110-1 through 2110-N can be coupled to an N×2n switch circuit 2120 that has 2n output paths 2121-1 through 2121-2n. Switch circuit 2120 can incorporate any of the switch circuit implementations described above or other implementations as desired. Operation of switch circuit 2120 can be controlled by classical control logic circuit 2140. Classical control logic circuit 2140 (like other classical logic circuits described herein) can be implemented using a microprocessor, microcontroller, field programmable gate array (FPGA), application-specific integrated circuit (ASIC) or any other digital logic circuitry. In some embodiments, classical control logic circuit 2140 can be integrated into a photonic/electronic circuit that also includes switch circuit 2120. In other embodiments, classical control logic circuit 2140 can be implemented in a separate device, and in some embodiments the separate device may be a classical computer system that can include a programmable processor and other supporting components. In operation, classical control logic circuit 2140 can receive the classical result signals R(1) through R(N) from HSPS pairs 2102-1 through 2102-N. Based on the pattern of the classical result signals, classical control logic circuit 2140 can select a set of 2n HSPS pairs that produced success states from among HSPS pairs 2102-1 through 2102-N and can generate control signals (CTL) to set the state of the active switches in switch circuit 2120 such that the signal path 2110-i of each HSPS pair 2102-i in the selected set is optically coupled to one of the output paths 2121-1 through 2121-2n. In some embodiments, a lookup table can be used to map different combinations of classical result signals R(1) through R(N) to corresponding combinations of active switch settings that effect the desired optical coupling.

Output paths 2121-1 through 2121-2n can be coupled to the input paths of a 2n×2n mode coupler network 2122, which can be similar or identical to mode coupler network 2022 described above. Outputs of mode coupler network 2122 can be coupled to detectors 2124-1 through 2124-2n, which can be similar or identical to detectors 1124-1 through 1124-4 described above. Classical data signals output from detectors 2124-1 through 2124-2n can be coupled to classical decision logic circuit 2130, which can determine whether an n-GHZ state is present on 2n of the output paths 2108-1 through 2108-N. The configuration and operation of classical decision logic circuit 2130 can be similar or identical to classical decision logic circuit 2030 described above.

In this manner, circuit 2100 can produce an n-GHZ state on 2n of output paths 2108-1 through 2108-N. More specifically, the n-GHZ state is produced on the 2n output paths 2108-i from the set of 2n HSPS pairs 2102-i selected by classical control logic 2140. Other (“non-selected”) output paths 2108-j may or may not carry photons. In some embodiments, blocking switches can be included on output paths 2108-1 through 2108-N and used to ensure that non-selected output paths do not propagate stray photons into downstream optical components. (Examples of blocking switches are described above.) In some embodiments, classical control logic circuit 2140 can provide an output signal indicating which 2n HSPS pairs 2102 were selected. This output signal can be used by downstream circuits; a particular use of output signals is not relevant to understanding the present disclosure.

Circuit 2100 can produce the same n-GHZ states as circuit 2000. As with circuit 2000, output paths 2108 of circuit 2100 need not pass through any mode coupling devices. The absence of mode coupling devices may improve transmission efficiency. Where the single photon sources are non-deterministic sources, circuit 2100 provides an increased probability of success as compared to circuit 2000 by increasing the number of HSPS pairs (and therefore the number of attempts at generating photons in a given cycle). The number N of HSPS pairs can be selected as desired (provided that N is greater than 2n), and for large enough N the probability of generating a photon in each of (at least) 2n HSPS pairs can approach 1.

Any of the switch circuits described above, with appropriate modification in the number of inputs and outputs, can be used as switch circuit 2120. For example, switch circuit 2120 can be a full N×2n multiplexing switch, in which any combination of 2n of the input paths 2110 can be optically coupled to the 2n output paths 2121. Simpler switch circuits can also be used, such as a set of 2n (N/2n)×1 mux circuits (analogous to switch circuit 1320 of FIG. 13). In some embodiments, the complexity of switch circuit 2120 can be reduced by increasing the size of the mode coupler network, analogously to circuit 1400 of FIG. 14. As noted above, using a larger mode coupler network can reduce the complexity of the switch network sued to select inputs to the mode coupler network. Since active optical switches generally have higher loss than passive mode couplers, enlarging the mode coupler network and reducing the complexity of the switch network can reduce optical loss. In various embodiments, the size of the mode coupler network can be chosen as desired; for instance any size from 2n to N (the number of HSPS pairs) can be chosen. Analogously to circuit 1700 of FIG. 17, the size of the mode coupler network can be equal to the number of HSPS pairs, and the switch circuit can be omitted in favor of blocking switches on optical paths 2110-1 through 2110-N

### 3. Additional Embodiments

The foregoing examples of entangled-state generator circuits and techniques are illustrative and can be modified as desired. All numerical examples are for purposes of illustration and can be modified. Any number N of HSPS pairs can be provided, as long as N is at least 4 (for Bell state generators), at least 2n (for n-GHZ state generators), or large enough to produce a target entangled state having a desired number of qubits. (In a dual-rail encoding, an n-qubit state is produced on 2n waveguides or paths.) The optimal number of HSPS pairs depends on various design considerations, including the efficiency of the heralded single photon sources. It should be noted that in entanglement-generating circuits of the kind described above, the two output paths (“s₀” and “s₁” of each HSPS pair) are treated differently. For instance, the s₁ output paths are input to switching and/or mode coupling networks while the so paths need not include any other optical elements. It should be understood that the so output paths may be coupled to downstream optical elements which can include any combination of active and/or passive optical elements, detectors, or any other optical element(s), depending on the particular application. (For example, in circuit 1800, the s₀ output paths are shown as coupled to beam splitters 1832.) Any such elements can be optimized independently of the entangled-state generator circuits described herein.

The number n of qubits in the target entangled state can be as large or small as desired, with n=2 being the minimum size for an entangled state of multiple qubits. The number N of HSPS pairs and the number of input (and output) modes in the mode coupler network can be but need not be powers of 2. For the mode coupler network, complex Hadamard matrices that provide mode information erasure can be defined in any dimension, with the Discrete Fourier Transform (DFT) being one example; accordingly, the mode coupler network can have any size. Further N and n need not satisfy any particular relationship, as long as Nis at least equal to 2n. (N less than 2n would not provide enough photons to produce an entangled state of n qubits.) Circuits described herein generate entanglement non-deterministically, meaning that in the ideal case of no photon loss, a given instance of operation with correct inputs may result in either success (i.e., the target entangled state) or failure. In general, larger n is associated with lower probability of success.

As noted above, the size of the mode coupler network can be varied, provided that the number of input paths is equal to the number of output paths and that this number is at least large enough to produce the target entangled state. (For Bell state generation, four input modes is a minimum size for the mode coupler network; more generally, for n-GHZ state generation, 2n input nodes is the minimum). If desired, the size of the mode coupler network can be increased up to N input paths (where Nis the number of HSPS pairs). As described above, for a given number N of HSPS pairs, using a larger mode coupler network can decrease the complexity of the active switch circuit, which may be an advantageous tradeoff. Use of mode coupler networks with more than N inputs is not precluded; however, there may be no benefit that would offset the added size and complexity of a larger mode coupler network. The mode coupler network can be a passive network of beam splitters and phase shifters. The particular structure of the mode coupler network can be modified as desired, provided that the mode coupler network has the property that a photon entering the mode coupler network on any one of the input paths has an equal probability of exiting on any one of the output paths.

Switch circuits can be implemented using active optical switches, a generalized Mach Zehnder interferometer (GMZI), or the like. In some embodiments, the switch circuit can support simultaneously coupling any combination of inputs to the outputs; this design choice generally results in a maximum switch depth. As described above, the switch circuit can group inputs and select among groups using a single-output multiplexer, which can reduce the switch depth; a design tradeoff is that, where inputs are grouped, not all possible combinations of successful HSPS pairs can be used to generate the target state. For instance, in the case of a Bell state, if the four successful HSPS pairs are all coupled to the same multiplexer, the switch circuit would not be able to propagate all four outputs. As described above, the number of combinations that can be used can be increased by providing additional 2×2 switches upstream of the multiplexers. Other variations and combinations of these and other techniques for constructing switch circuits can be used.

Embodiments described above provide examples of systems and methods for generating entangled n-qubit states. Examples include Bell states, which are quantum systems that can represent two maximally entangled qubits, and n-GHZ states, which are quantum systems that can represent a number n of maximally entangled qubits for any n≥2. (A Bell state can be regarded as a “2-GHZ” state.) Bell states and other n-GHZ states have a variety of applications in quantum communication and quantum computing, and entangled states generated using techniques described herein can be used in any such application involving photonic qubits.

Embodiments described above make use of heralded single photon source pairs. Those skilled in the art with access to this disclosure will understand that the output of a heralded single photon source pair (such as HSPS pair 1102-1 described above) can be interpreted as a qubit having a dual-rail encoding (as described above). In this interpretation, the success state of the HSPS pair corresponds to production of a qubit in a superposition of logical-0 and logical-1 states. Accordingly, heralded single photon source pairs of the kind described herein can be used in a variety of applications where production of qubits in superposition states is desired, including but not limited to generation of Bell states, n-GHZ states, or other multi-qubit entangled states.

Further, embodiments described above include references to specific materials and structures (e.g., optical fibers), but other materials and structures capable of producing, propagating, and operating on photons can be substituted. Techniques described herein exploit the properties of photon sources that produce pairs of photons. Similar techniques can be used with a variety of photon sources and may also be adapted to qubits that are realized using entities other than photons that propagate along well-defined hardware paths.

Classical control logic and/or classical decision logic circuits can be implemented on-chip with the waveguides, beam splitters, detectors and/or and other photonic circuit components or off-chip as desired. Any of the classical logic circuits described herein can be implemented using a microprocessor, microcontroller, field programmable gate array (FPGA), application-specific integrated circuit (ASIC) or any other digital logic circuitry. In some embodiments, some or all of the classical logic circuits can be implemented in a classical computer system such as classical computer system 1003 described above.

The following are example embodiments:

Example 1: A circuit comprising: a first heralded single photon source operable to produce a pair of first photons, the first heralded single photon source having a first signal output path to receive a first photon of the pair of first photons and a first herald output path to receive a second photon of the pair of first photons; a second heralded single photon source operable to produce a pair of second photons, the second heralded single photon source having a second signal output path to receive a first photon of the pair of second photons and a second herald output path to receive a second photon of the pair of second photons; a mode coupling optical circuit coupled between the first herald output path and the second herald output path, the mode coupling optical circuit having a first mode-coupling output path and a second mode-coupling output path; a first detector configured to detect photons from the first mode-coupling output path; a second detector configured to detect photons from the second mode-coupling output path; and a classical decision logic circuit coupled to the first detector and the second detector and configured to determine whether a photon was detected on exactly one of the first mode-coupling output path and the second mode-coupling output path and to generate a success signal indicating whether a photon was detected on exactly one of the first mode-coupling output path and the second mode-coupling output path.

Example 2: The circuit of Example 1 wherein the first heralded single photon source is configured such that the first photon of the pair of first photons has a first frequency and the second photon of the pair of first photons has a second frequency different from the first frequency.

Example 3: The circuit of Example 1 or Example 2 wherein the second heralded single photon source is configured such that first photon of the pair of second photons has a third frequency and the second photon of the pair of second photons has the second frequency.

Example 4: The circuit of any one of Examples 1-3 wherein the first frequency and the third frequency are different frequencies.

Example 5: The circuit of any one of Examples 1˜4 wherein the first frequency and the third frequency are the same frequency.

Example 6: A circuit comprising: a plurality of heralded single photon source pairs, wherein each heralded single photon source pair has a first output optical path, a second output optical path, and a digital logic output signal path, wherein each heralded single photon source pair is configured to generate photons on the first and second output paths, to determine whether exactly one photon is present on the first and second output paths without determining on which of the first and second output paths the exactly one photon is present, and to output a success signal on the digital logic output signal path, the success signal indicating whether exactly one photon is present on the first and second output paths; a mode coupler network having at least four inputs and at least four outputs, the number of outputs being equal to the number of inputs, the mode coupler network being configured such that a photon received on any one of the inputs has an equal probability of being output on any one of the outputs; a switch circuit coupled to the second output path of each of the heralded single photon source pairs and configured to selectably couple the second output paths of a subset of the heralded single photon source pairs to the inputs of the mode coupler network; a classical control logic circuit coupled to the switch circuit and configured to receive the success signals from the plurality of heralded single photon source pairs and to generate control signals for the switch circuit based on the success signals; a plurality of detectors coupled to the outputs of the mode coupler network and configured to detect photons; and a classical decision logic circuit coupled to the detectors and configured to determine, based on signals received from the detectors, whether a target entangled state of a number n of qubits is present on a number 2n of the first output optical paths, wherein n is an integer greater than or equal to 2.

Example 7: The circuit of Example 6 wherein n is equal to 2 and the target entangled state is a Bell state of two qubits.

Example 8: The circuit of Example 6 or Example 7 wherein n is greater than 2 and the target entangled state is an n-GHZ state.

Example 9: The circuit of any one of Examples 6-8 wherein each heralded single photon source pair includes: a first heralded single photon source operable to produce a pair of first photons, the first heralded single photon source having a first signal output path to receive a first photon of the pair of first photons and a first herald output path to receive a second photon of the pair of first photons; a second heralded single photon source operable to produce a pair of second photons, the second heralded single photon source having a second signal output path to receive a first photon of the pair of second photons and a second herald output path to receive a second photon of the pair of second photons; a mode coupling optical circuit coupled between the first herald output path and the second herald output path, the mode coupling optical circuit having a first mode-coupling output path and a second mode-coupling output path; a first detector configured to detect photons from the first mode-coupling output path; a second detector configured to detect photons from the second mode-coupling output path; and a classical decision logic circuit coupled to the first detector and the second detector and configured to determine, based on photon count signals from the first detector and the second detector, whether exactly one photon is present on the first and second output paths and to generate the success signal.

Example 10: The circuit of any one of Examples 6-9 wherein the first heralded single photon source is configured such that the first photon of the pair of first photons has a first frequency and the second photon of the pair of first photons has a second frequency different from the first frequency.

Example 11: The circuit of any one of Examples 6-10 wherein the second heralded single photon source is configured such that first photon of the pair of second photons has a third frequency and the second photon of the pair of second photons has the second frequency.

Example 12: The circuit of any one of Examples 6-11 wherein the first frequency and the third frequency are different frequencies.

Example 13: The circuit of any one of Examples 6-12 wherein the first frequency and the third frequency are the same frequency.

Example 14: The circuit of any one of Examples 6-13 wherein the classical control logic circuit is configured to identify a set of 2n heralded single photon sources for which the success signals indicate that exactly one photon is present on the first and second output paths and to generate the control signals such that the second output paths of the heralded single photon sources in the set of 2n heralded single photon sources are coupled to the inputs of the mode coupler network.

Example 15: The circuit of any one of Examples 6-14 wherein the switch circuit includes a network of active optical switches that is configurable in response to the control signals to couple any combination of 2n of the second output paths of the heralded single photon sources to the inputs of the mode coupler network.

Example 16: The circuit of any one of Examples 6-15 wherein the switch circuit includes a set of multiplexer circuits, each multiplexer circuit having an output path coupled to a respective one of the inputs of the mode coupler network and a plurality of input paths, wherein the input paths of different ones of the multiplexer circuits are coupled to the second output paths of different ones of the heralded single photon sources.

Example 17: The circuit of any one of Examples 6-16 wherein the mode coupler network includes exactly 2n inputs.

Example 18: The circuit of any one of Examples 6-17 wherein the mode coupler network includes more than 2n inputs and fewer than a number N of inputs, wherein Nis the number of heralded single photon source pairs.

Example 19: A circuit comprising: a plurality of heralded single photon source pairs, wherein each heralded single photon source pair has a first output optical path, a second output optical path, and a digital logic output signal path, wherein the heralded single photon source pair is configured to generate photons on the first and second output paths, to determine whether exactly one photon is present on the first and second output paths without determining on which of the first and second output paths the exactly one photon is present, and to output a success signal on the digital logic output signal path, the success signal indicating whether exactly one photon is present on the first and second output paths; a mode coupler network having a plurality of inputs and a plurality of outputs, the mode coupler network being configured such that a photon received on any one of the inputs has an equal probability of being output on any one of the outputs, wherein the inputs of the mode coupler network are coupled to the second output optical paths of the heralded single photon source pairs; a plurality of detectors coupled to the outputs of the mode coupler network and configured to detect photons; and a classical decision logic circuit coupled to the detectors and configured to determine, based on signals received from the detectors, whether a target entangled state of a number n of qubits is present on 2n of the first output optical paths, wherein n is an integer greater than or equal to 2.

Example 20: The circuit of Example 19 wherein n is equal to 2 and the target entangled state is a Bell state of two qubits.

Example 21: The circuit of Example 19 or Example 20 wherein n is greater than 2 and the target entangled state is an n-GHZ state.

Example 22: The circuit of any one of Examples 19-21 further comprising: a plurality of blocking switches, each blocking switch having an input coupled to the second output path of one of the heralded single photon source pairs and an output coupled to one of the inputs of the mode coupler network; and a classical control logic circuit coupled to the blocking switches and configured to receive the success signals from the plurality of heralded single photon source pairs and to generate control signals for the blocking switches based on the success signals.

Example 23: The circuit of any one of Examples 19-22 wherein the classical control logic circuit is configured to identify a set of 2n of the heralded single photon sources for which the success signals indicate that exactly one photon is present on the first and second output paths and to generate the control signals such that the blocking switches coupled to second output paths of the heralded photon sources in the set of 2n of the heralded single photon sources are in a pass-through state and the remaining blocking switches are in a blocking state.

It should be understood that all numerical values used herein are for purposes of illustration and may be varied. In some instances ranges are specified to provide a sense of scale, but numerical values outside a disclosed range are not precluded.

It should also be understood that all diagrams herein are intended as schematic. Unless specifically indicated otherwise, the drawings are not intended to imply any particular physical arrangement of the elements shown therein, or that all elements shown are necessary. Those skilled in the art with access to this disclosure will understand that elements shown in drawings or otherwise described in this disclosure can be modified or omitted and that other elements not shown or described can be added. The terms “upstream” and “downstream” are used herein in reference to the direction of photon propagation along an optical path such as an optical fiber or other waveguide and are not intended to imply any particular physical arrangement of waveguides.

This disclosure provides a description of the claimed invention with reference to specific embodiments. Those skilled in the art with access to this disclosure will appreciate that the embodiments are not exhaustive of the scope of the claimed invention, which extends to all variations, modifications, and equivalents.

What is claimed is:

1. A circuit comprising:
a first heralded single photon source operable to produce a pair of first photons, the first heralded single photon source having a first signal output path to receive a first photon of the pair of first photons and a first herald output path to receive a second photon of the pair of first photons;
a second heralded single photon source operable to produce a pair of second photons, the second heralded single photon source having a second signal output path to receive a first photon of the pair of second photons and a second herald output path to receive a second photon of the pair of second photons;
a mode coupling optical circuit coupled between the first herald output path and the second herald output path, the mode coupling optical circuit having a first mode-coupling output path and a second mode-coupling output path;
a first detector configured to detect photons from the first mode-coupling output path;
a second detector configured to detect photons from the second mode-coupling output path; and
a classical decision logic circuit coupled to the first detector and the second detector and configured to determine whether a photon was detected on exactly one of the first mode-coupling output path and the second mode-coupling output path and to generate a success signal indicating whether a photon was detected on exactly one of the first mode-coupling output path and the second mode-coupling output path.

2. The circuit of claim 1 wherein the first heralded single photon source is configured such that the first photon of the pair of first photons has a first frequency and the second photon of the pair of first photons has a second frequency different from the first frequency.

3. The circuit of claim 2 wherein the second heralded single photon source is configured such that first photon of the pair of second photons has a third frequency and the second photon of the pair of second photons has the second frequency.

4. The circuit of claim 3 wherein the first frequency and the third frequency are different frequencies.

5. The circuit of claim 3 wherein the first frequency and the third frequency are the same frequency.

6. A circuit comprising:
a plurality of heralded single photon source pairs, wherein each heralded single photon source pair has a first output optical path, a second output optical path, and a digital logic output signal path, wherein each heralded single photon source pair is configured to generate photons on the first and second output paths, to determine whether exactly one photon is present on the first and second output paths without determining on which of the first and second output paths the exactly one photon is present, and to output a success signal on the digital logic output signal path, the success signal indicating whether exactly one photon is present on the first and second output paths;
a mode coupler network having at least four inputs and at least four outputs, the number of outputs being equal to the number of inputs, the mode coupler network being configured such that a photon received on any one of the inputs has an equal probability of being output on any one of the outputs;
a switch circuit coupled to the second output path of each of the heralded single photon source pairs and configured to selectably couple the second output paths of a subset of the heralded single photon source pairs to the inputs of the mode coupler network;
a classical control logic circuit coupled to the switch circuit and configured to receive the success signals from the plurality of heralded single photon source pairs and to generate control signals for the switch circuit based on the success signals;
a plurality of detectors coupled to the outputs of the mode coupler network and configured to detect photons; and
a classical decision logic circuit coupled to the detectors and configured to determine, based on signals received from the detectors, whether a target entangled state of a number n of qubits is present on a number 2n of the first output optical paths, wherein n is an integer greater than or equal to 2.

7. The circuit of claim 6 wherein n is equal to 2 and the target entangled state is a Bell state of two qubits.

8. The circuit of claim 6 wherein n is greater than 2 and the target entangled state is an n-GHZ state.

9. The circuit of claim 6 wherein each heralded single photon source pair includes:
a first heralded single photon source operable to produce a pair of first photons, the first heralded single photon source having a first signal output path to receive a first photon of the pair of first photons and a first herald output path to receive a second photon of the pair of first photons;
a second heralded single photon source operable to produce a pair of second photons, the second heralded single photon source having a second signal output path to receive a first photon of the pair of second photons and a second herald output path to receive a second photon of the pair of second photons;
a mode coupling optical circuit coupled between the first herald output path and the second herald output path, the mode coupling optical circuit having a first mode-coupling output path and a second mode-coupling output path;
a first detector configured to detect photons from the first mode-coupling output path;
a second detector configured to detect photons from the second mode-coupling output path; and
a classical decision logic circuit coupled to the first detector and the second detector and configured to determine, based on photon count signals from the first detector and the second detector, whether exactly one photon is present on the first and second output paths and to generate the success signal.

10. The circuit of claim 9 wherein the first heralded single photon source is configured such that the first photon of the pair of first photons has a first frequency and the second photon of the pair of first photons has a second frequency different from the first frequency.

11. The circuit of claim 10 wherein the second heralded single photon source is configured such that first photon of the pair of second photons has a third frequency and the second photon of the pair of second photons has the second frequency.

12. The circuit of claim 11 wherein the first frequency and the third frequency are different frequencies.

13. The circuit of claim 11 wherein the first frequency and the third frequency are the same frequency.

14. The circuit of claim 6 wherein the classical control logic circuit is configured to identify a set of 2n heralded single photon sources for which the success signals indicate that exactly one photon is present on the first and second output paths and to generate the control signals such that the second output paths of the heralded single photon sources in the set of 2n heralded single photon sources are coupled to the inputs of the mode coupler network.

15. The circuit of claim 6 wherein the switch circuit includes a network of active optical switches that is configurable in response to the control signals to couple any combination of 2n of the second output paths of the heralded single photon sources to the inputs of the mode coupler network.

16. The circuit of claim 6 wherein the switch circuit includes a set of multiplexer circuits, each multiplexer circuit having an output path coupled to a respective one of the inputs of the mode coupler network and a plurality of input paths, wherein the input paths of different ones of the multiplexer circuits are coupled to the second output paths of different ones of the heralded single photon sources.

17. The circuit of claim 6 wherein the mode coupler network includes exactly 2n inputs.

18. The circuit of claim 6 wherein the mode coupler network includes more than 2n inputs and fewer than a number N of inputs, wherein Nis the number of heralded single photon source pairs.

19. A circuit comprising:
a plurality of heralded single photon source pairs, wherein each heralded single photon source pair has a first output optical path, a second output optical path, and a digital logic output signal path, wherein the heralded single photon source pair is configured to generate photons on the first and second output paths, to determine whether exactly one photon is present on the first and second output paths without determining on which of the first and second output paths the exactly one photon is present, and to output a success signal on the digital logic output signal path, the success signal indicating whether exactly one photon is present on the first and second output paths;
a mode coupler network having a plurality of inputs and a plurality of outputs, the mode coupler network being configured such that a photon received on any one of the inputs has an equal probability of being output on any one of the outputs, wherein the inputs of the mode coupler network are coupled to the second output optical paths of the heralded single photon source pairs;
a plurality of detectors coupled to the outputs of the mode coupler network and configured to detect photons; and
a classical decision logic circuit coupled to the detectors and configured to determine, based on signals received from the detectors, whether a target entangled state of a number n of qubits is present on 2n of the first output optical paths, wherein n is an integer greater than or equal to 2.

20. The circuit of claim 19 wherein n is equal to 2 and the target entangled state is a Bell state of two qubits.

21. The circuit of claim 19 wherein n is greater than 2 and the target entangled state is an n-GHZ state.

22. The circuit of claim 19 further comprising:
a plurality of blocking switches, each blocking switch having an input coupled to the second output path of one of the heralded single photon source pairs and an output coupled to one of the inputs of the mode coupler network; and
a classical control logic circuit coupled to the blocking switches and configured to receive the success signals from the plurality of heralded single photon source pairs and to generate control signals for the blocking switches based on the success signals.

23. The circuit of claim 22 wherein the classical control logic circuit is configured to identify a set of 2n of the heralded single photon sources for which the success signals indicate that exactly one photon is present on the first and second output paths and to generate the control signals such that the blocking switches coupled to second output paths of the heralded photon sources in the set of 2n of the heralded single photon sources are in a pass-through state and the remaining blocking switches are in a blocking state.
